(19) United States
(12) Patent Application Publication
(10) Pub. No.: US 2025/0176029 A1
(43) Pub. Date: May 29, 2025

(54) PERFORMING MULTIPLE PARALLEL RANDOM ACCESS PROCEDURES

(71) Applicant: QUALCOMM Incorporated, San Diego, CA (US)

(72) Inventors: Shaozhen GUO, Beijing (CN); Mostafa KHOSHNEVISAN, San Diego, CA (US); Peter GAAL, San Diego, CA (US); Jing SUN, San Diego, CA (US); Xiaoxia ZHANG, San Diego, CA (US); Tao LUO, San Diego, CA (US); Yan ZHOU, San Diego, CA (US); Fang YUAN, Beijing (CN)

(21) Appl. No.: 18/834,369

(22) PCT Filed: Mar. 31, 2022
(86) PCT No.: PCT/CN2022/084357

§ 371 Date: Jul. 30, 2024

(51) Int. Cl. H04W 74/0833

(52) U.S. Cl. CPC H04W 74/0833

(57) ABSTRACT

Methods, systems, and devices for wireless communications are described. In some systems, a user equipment (UE) may support multiple parallel random access procedures for multiple transmission reception points (TRPs) or for component carriers (CCs) in different TAGs if one or more conditions are satisfied. A UE may support parallel random access procedures for a same CC configured with two TAGs (e.g., if the control resource set (CORESET) pool indices for the random access procedures are different). A UE may support parallel random access procedures for different CCs associated with different TAGs. A UE may support parallel random access procedures for different CCs across or within sets of CCs. A UE may support random access procedures for a same CC or different CCs if the random access procedures associated with a same CC have different CORESET pool indices, and additional random access procedures are associated with different CCs and different TAGs.

### CROSS REFERENCE

The present Application is a 371 national phase filing of International PCT Application No. PCT/CN2022/084357 by GUO et al., entitled “PERFORMING MULTIPLE PARALLEL RANDOM ACCESS PROCEDURES,” filed Mar. 31, 2022, which is assigned to the assignee hereof, and which is expressly incorporated by reference in its entirety herein.

### FIELD OF TECHNOLOGY

The following relates to wireless communications, including performing multiple parallel random access procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support performing multiple parallel random access procedures. For example, the described techniques provide for a communication device that may support multiple parallel random access procedures for multiple transmission reception points (TRPs) or for component carriers (CCs) in different timing advance groups (TAGs) if one or more conditions are satisfied. For example, a communication device may support up to two parallel random access procedures for a same CC configured with two TAGs and two control resource set (CORESET) pool indices. In some examples, a communication device may support up to four parallel random access procedures for different CCs that are each associated with a different TAG. In some examples, a communication device may support up to four parallel random access procedures for different CCs across or within sets of CCs (e.g., may support two parallel RACH procedures in different sets of CCs defined by different TAGs, and may also support up to two parallel random access procedures within sets of CCs for one or two CCs if the two random access procedures are triggered by PDCCH orders associated with different CORESET pool indices). In some examples, the communication device may support up to four random access procedures for a same CC or different CCs if two random access procedures associated with a same CC have different CORESET pool indices, and additional random access procedures are associated with different CCs and different TAGS.

A method for wireless communications at a user equipment (UE) is described. The method may include receiving a first control message triggering a first random access procedure, transmitting a first random access preamble message associated with the first random access procedure based on receiving the first control message, receiving a second control message triggering a second random access procedure, and transmitting, prior to completion of the first random access procedure and based on one or more conditions being satisfied, a second random access preamble message associated with the second random access procedure based on receiving the second control message.

An apparatus for wireless communications at a UE is described. The apparatus may include a processor, memory coupled with the processor, and instructions stored in the memory. The instructions may be executable by the processor to cause the apparatus to receive a first control message triggering a first random access procedure, transmit a first random access preamble message associated with the first random access procedure based on receiving the first control message, receive a second control message triggering a second random access procedure, and transmit, prior to completion of the first random access procedure and based on one or more conditions being satisfied, a second random access preamble message associated with the second random access procedure based on receiving the second control message.

Another apparatus for wireless communications at a UE is described. The apparatus may include means for receiving a first control message triggering a first random access procedure, means for transmitting a first random access preamble message associated with the first random access procedure based on receiving the first control message, means for receiving a second control message triggering a second random access procedure, and means for transmitting, prior to completion of the first random access procedure and based on one or more conditions being satisfied, a second random access preamble message associated with the second random access procedure based on receiving the second control message.

A non-transitory computer-readable medium storing code for wireless communications at a UE is described. The code may include instructions executable by a processor to receive a first control message triggering a first random access procedure, transmit a first random access preamble message associated with the first random access procedure based on receiving the first control message, receive a second control message triggering a second random access procedure, and transmit, prior to completion of the first random access procedure and based on one or more conditions being satisfied, a second random access preamble message associated with the second random access procedure based on receiving the second control message.

Some examples of the method, apparatuses, and non-transitory computer-readable medium described herein may further include operations, features, means, or instructions for receiving signaling indicating a configuration of a first component carrier associated with a first timing advance group and a second timing advance group, where the first random access procedure and the second random access procedure may be associated with the first component carrier and determining that the one or more conditions may be satisfied based on a first control resource set pool index associated with the first control message being different than a second control resource set pool index associated with the second control message.

Some examples of the method, apparatuses, and non-transitory computer-readable medium described herein may further include operations, features, means, or instructions for receiving signaling indicating a configuration of a first timing advance group associated with a first component carrier, and a second timing advance group associated with a second component carrier, where the first random access procedure may be associated with the first component carrier and the second random access procedure may be associated with the second component carrier and determining that the one or more conditions may be satisfied based on a first component carrier being associated with the first timing advance group and the second component carrier being associated with the second timing advance group that may be different than the first timing advance group.

Some examples of the method, apparatuses, and non-transitory computer-readable medium described herein may further include operations, features, means, or instructions for receiving signaling indicating a configuration of a first set of component carriers and a second set of component carriers, where each component carrier of the first set of component carriers may be associated with one or more timing advance groups of a first set of timing advance groups and each component carrier of the second set of component carriers may be associated with one or more timing advance groups of a second set of timing advance groups and determining that the one or more conditions may be satisfied based on the first random access procedure being triggered for a first component carrier of the first set of component carriers and the second random access procedure being triggered for a first component carrier of the second set of component carriers.

In some examples of the method, apparatuses, and non-transitory computer-readable medium described herein, the UE supports up to two random access procedures that at least partially overlap in time for the first set of component carriers and up to two random access procedures that at least partially overlap in time for the second set of component carriers based on the one or more conditions being satisfied.

Some examples of the method, apparatuses, and non-transitory computer-readable medium described herein may further include operations, features, means, or instructions for determining that the one or more conditions may be satisfied based on each random access procedure associated with a respective set of component carriers being associated with different control resource set pool indices.

Some examples of the method, apparatuses, and non-transitory computer-readable medium described herein may further include operations, features, means, or instructions for receiving signaling indicating a configuration of a first component carrier associated with a first timing advance group and a second timing advance group and a second component carrier associated with at least a third timing advance group, and where the first random access procedure and the second random access procedure may be associated with the first component carrier, determining that the one or more conditions may be satisfied based on a first control resource set pool index associated with the first control message being different than a second control resource set pool index associated with the second control message, receiving a third control message triggering a third random access procedure associated with the second component carrier and the third timing advance group, determining that the one or more conditions may be satisfied based on the third timing advance group being different from the first timing advance group and the second timing advance group, and transmitting, prior to completion of the first random access procedure based on the one or more conditions being satisfied, a third random access preamble message associated with a third random access procedure based on receiving the third control message.

Some examples of the method, apparatuses, and non-transitory computer-readable medium described herein may further include operations, features, means, or instructions for receiving a first random access response message associated with the first random access procedure based on transmitting the first random access preamble message and receiving a second random access response message associated with the second random access procedure based on transmitting the second random access preamble message.

Some examples of the method, apparatuses, and non-transitory computer-readable medium described herein may further include operations, features, means, or instructions for transmitting a capability message indicating that the UE may be capable of supporting multiple random access procedures that at least partially overlap in time, where receiving the second control message triggering the second random access procedure may be based on transmitting the capability message.

In some examples of the method, apparatuses, and non-transitory computer-readable medium described herein, the capability message includes an indication of a threshold number of random access procedures that at least partially overlap in time that the UE may be capable of supporting, an indication of the one or more conditions, or both.

Some examples of the method, apparatuses, and non-transitory computer-readable medium described herein may further include operations, features, means, or instructions for receiving a third control message triggering a third random access procedure prior to completion of the first random access procedure, determining that the one or more conditions may be not satisfied for the third random access procedure, and refraining from initiating the third random access procedure, or initiating the third random access procedure and terminating the first random access procedure, based on the determining.

Some examples of the method, apparatuses, and non-transitory computer-readable medium described herein may further include operations, features, means, or instructions for receiving a third control message triggering a third random access procedure prior to completion of the first random access procedure, determining that the third random access procedure exceeds a threshold number of random access procedures that at least partially overlap in time supported by the UE, and refraining from initiating the third random access procedure based on the determining.

Some examples of the method, apparatuses, and non-transitory computer-readable medium described herein may further include operations, features, means, or instructions for receiving the first control message includes receiving the first control message from a first network entity and receiving the second control message includes receiving the second control message from a second network entity.

### BRIEF DESCRIPTION OF THE DRAWINGS

FIG. 1 illustrates an example of a wireless communications system that supports performing multiple parallel random access procedures in accordance with one or more aspects of the present disclosure.

FIG. 2 illustrates an example of a timeline that supports performing multiple parallel random access procedures in accordance with one or more aspects of the present disclosure.

FIG. 3 illustrates an example of a timeline that supports performing multiple parallel random access procedures in accordance with one or more aspects of the present disclosure.

FIG. 4 illustrates an example of a process flow that supports performing multiple parallel random access procedures in accordance with one or more aspects of the present disclosure.

FIG. 5 illustrates an example of a process flow that supports performing multiple parallel random access procedures in accordance with one or more aspects of the present disclosure.

FIG. 6 illustrates an example of a process flow that supports performing multiple parallel random access procedures in accordance with one or more aspects of the present disclosure.

FIG. 7 illustrates an example of a process flow that supports performing multiple parallel random access procedures in accordance with one or more aspects of the present disclosure.

FIGS. 8 and 9 show block diagrams of devices that support performing multiple parallel random access procedures in accordance with one or more aspects of the present disclosure.

FIG. 10 shows a block diagram of a communications manager that supports performing multiple parallel random access procedures in accordance with one or more aspects of the present disclosure.

FIG. 11 shows a diagram of a system including a device that supports performing multiple parallel random access procedures in accordance with one or more aspects of the present disclosure.

FIGS. 12 through 15 show flowcharts illustrating methods that support performing multiple parallel random access procedures in accordance with one or more aspects of the present disclosure.

### DETAILED DESCRIPTION

In some wireless communications systems, a user equipment (UE) and a network entity (e.g., one or more transmit/receive points (TRPs)) may perform a random access channel (RACH) procedure. A TRP may trigger a first RACH procedure by transmitting a physical downlink control channel (PDCCH) order to the UE. The UE may then transmits a first RACH message to the TRP during the first RACH procedure and may monitor for a second RACH message from the TRP during a time window. If the UE receives the second RACH message that includes a RACH preamble identifier that matches a preamble transmitted in the first RACH message, the UE may consider the first RACH procedure to be successfully completed. If the UE does not receive the second RACH message, or if a received second RACH message does not include a preamble that matches the preamble of the first RACH message after the time window expires, the TRP may trigger a RACH retransmission. The UE may consider the first RACH procedure to be successfully completed when one of the retransmitted second RACH messages is successfully received. The UE may consider the first RACH procedure to be unsuccessfully completed when a number of retransmissions satisfies a threshold.

Some UEs may support no more than one RACH procedure at any point in time. For multiple TRP (mTRP) environments, a UE may perform RACH procedures to synchronize with each of the multiple TRPs. However, performing a first RACH procedure with a first TRP, and then performing a second RACH procedure, after the first procedure is completed, with the second TRP may introduce increased latency for uplink synchronization. Similarly, for multiple component carriers (CCs) in different timing advance groups (TAGs), a RACH procedure for a second serving cell may not be performed until after the RACH procedure for a first serving cell is completed, which may introduce additional delay for timing alignment. If a UE supports no more than a single RACH procedure at a time, the UE experiences increased delays, failed or dropped communications, inefficient use of available system resources, and decreased user experience.

A UE may support multiple parallel random access procedures for multiple TRPs or for CCs in different TAGs if one or more conditions are satisfied. For example, A UE may support up to two parallel random access procedures for a same CC configured with two TAGs and two CORESET pool indices. In some examples, a UE may support up to four parallel random access procedures for different CCs that are each associated with a different TAG. In some examples, a UE may support up to four parallel random access procedures for different CCs across or within sets of CCs (e.g., may support two parallel RACH procedures in different sets of CCs defined by different TAGs, and may also support up to two parallel random access procedures within sets of CCs for one or two CCs if the two random access procedures are triggered by PDCCH orders associated with different CORESET pool indices). In some examples, the UE may support up to four random access procedures for a same CC or different CCs if two random access procedures associated with a same CC have different CORESET pool indices, and additional random access procedures are associated with different CCs and different TAGs.

Aspects of the disclosure are initially described in the context of wireless communications systems. Aspects of the disclosure are further illustrated by and described with reference to timelines and process flows. Aspects of the disclosure are further illustrated by and described with reference to apparatus diagrams, system diagrams, and flowcharts that relate to performing multiple parallel random access procedures.

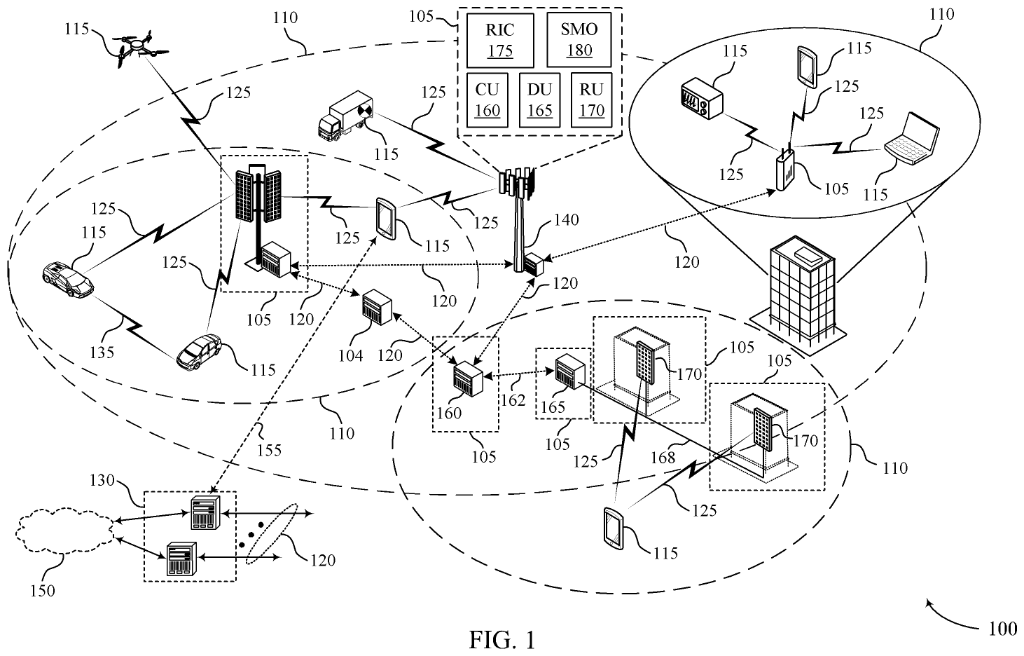

FIG. 1 illustrates an example of a wireless communications system 100 that supports performing multiple parallel random access procedures in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support performing multiple parallel random access procedures as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ns may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, a UE 115 and a network entity (e.g., one or more TRPs) may perform a random access channel (RACH) procedure. For a physical RACH (PRACH) transmission performed by the UE 115 and triggered by a physical downlink control channel (PDCCH) order, if the value of the RACH preamble index field is not zero, a PRACH mask index field may indicate the PRACH occasion for the PRACH transmission where the PRACH occasions are associated with the SS/PBCH block index indicated by the synchronization symbol (SS)/physical broadcast channel (PBCH) block index field of the PDCCH order.

In response to the PRACH transmission, a UE 115 may monitor for a RACH response (RAR). Accordingly, the UE 115 may attempt to detect a DCI format 1_0 with CRC scrambled by a corresponding RA-RNTI during a window controlled by higher layers. In some examples, the window may start at a first symbol of the earliest control resource set (CORESET) which the UE 115 is configured to receive PDCCH for Type1-PDCCH CSS set that is at least one symbol, after the last symbol of the PRACH occasion corresponding to the PRACH transmission, where the symbol duration corresponds to the subcarrier spacing (SCS) for a Type1-PDCCH CSS set. The length of the window in number of slots, based on the SCS for the Type1-PDCCH CSS set, may be provided by a ra-ResponseWindow.

If the UE 115 detects the DCI format 1_0 with a cyclic redundancy check (CRC) scrambled by the corresponding random access radio network temporary identifier (RA-RNTI) and least significant bits (LSBs) of a system frame number (SFN) field in the DCI format 1_0, if included and applicable, are the same as the corresponding LSBs of the SFN where the UE 115 transmitted the PRACH, and if the UE 115 receives a transport block (TB) in a corresponding physical downlink shared channel (PDSCH) within the window, then the UE 115 may pass the TB to higher layers. The higher layers may parse the TB for a RACH preamble identity (RAPID) associated with the PRACH transmission. If the higher layers identify the RAPID in one or more RAR messages of the TB, then the higher layers may indicate an uplink grant to the physical layer. This may be referred to as a RAR uplink (UL) grant in the physical layer.

If the UE 115 does not detect the DCI format 1_0 with CRC scrambled by the corresponding RA-RNTI within the window, or if the UE 115 detects the DCI format 1_0 with CRC scrambled by the corresponding RA-RNTI within the window and LSBs of a SFN field in the DCI format 1_0, if included and applicable, are not the same as the corresponding LSBs of the SFN where the UE 115 transmitted the PRACH, or if the UE 115 does not correctly receive the TB in the corresponding PDSCH within the window, or if the higher layers do not identify the RAPID associated with the PRACH transmission from the UE 115, the higher layers may indicate to the physical layer to transmit a PRACH. If requested by higher layers, the UE 115 may be expected to transmit a PRACH no later than N_{T,1}+0.75 msec after the last symbol of the window, or the last symbol of the PDSCH reception, where N_{T,1} may be a time duration of N_{T,1} symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For u=0, the UE 115 may assume N_{T,1}=14. For a PRACH transmission using 1.25 kHz or 5 kHz SCS, the UE 115 may determine N₁ assuming SCS configuration of u=0.

In some examples, if a valid downlink assignment has been received on the PDCCH for the RA-RNTI and the received TB is successfully decoded, then the RAR may contain a MAC sub-protocol data unit (subPDU) with a backoff indicator. In such examples, the UE 115 may set a PREAMBLE_BACKOFF parameter to a value of the backoff indicator (BI) field of the MAC PDU using a reference table, multiplied with a scaling factor (e.g., a SCALING_FACTOR_BI parameter). Additionally or alternatively, the UE 115 may set the PREAMBLE_BACKOFF to 0 ms.

In some cases, if the RAR contains a MAC subPDU with a RAPID corresponding to the transmitted PREAMBLE_INDEX, then the UE 115 may consider the RAR reception to be successful. If the UE 115 considers the RAR reception to be successful, and if the RAR includes a MAC subPDU with RAPID only, then the UE 115 may consider the random access procedure to be successfully completed. Additionally, or alternatively, the UE 115 may indicate the reception of an acknowledgement for SI request to upper layers. If the RAR does not include a MAC subPDU with RAPID only, then the UE 115 may apply certain actions for the serving cell where the RACH preamble was transmitted. In some examples, the UE 115 may process a received timing advance command. The UE 115 may indicate the preamble received target power (e.g., a preambleReceivedTargetPower parameter) and the amount of power ramping which may be applied to the latest RACH preamble transmission to lower layers (e.g., (PREAMBLE_POWER_RAMPING_COUNTER-1)×PREAMBLE_POWER_RAMPING_STEP). Additionally, or alternatively, if the random access procedure for an SCell is performed on an uplink carrier where a PUSCH configuration (e.g., a pusch-Config parameter) is not configured, then a UE 115 may ignore a received UL grant. The UE 115 may process the received UL grant value and indicate it to the lower layers.

If the UE 115 (e.g., a MAC entity) does not select the RACH preamble among one or more contention-based RACH preambles, then the UE 115 may consider the random access procedure to be successfully completed. Additionally, or alternatively, the UE 115 may set a TEMPORARY_C-RNTI parameter to a value received in the RAR. In some examples, if the RAR is the first successfully received RAR within the random access procedure, and if the transmission is not being made for the common control channel (CCCH) logical channel, then the UE 115 may indicate to the multiplexing and assembly entity to include a cell RNTI (C-RNTI) MAC CE in the subsequent uplink transmission. If the random access procedure is initiated for a special cell (SPCell) beam failure recovery (BFR) and an spCell-BFR-CBRA parameter with value true is configured, then the UE 115 may indicate to the multiplexing and assembly entity to include a BFR MAC-CE or a truncated BFR MAC-CE in the subsequent uplink transmission. The UE 115 may obtain the MAC PDU to transmit from the multiplexing and assembly entity and store it in the Msg3 buffer.

In some examples, if a ra-ResponseWindow configured in a RACH-ConfigCommon expires, and if the RAR containing one or more RAPIDS which match the transmitted PREAMBLE_INDEX has not been received, then the UE 115 may consider the RAR reception to be unsuccessful. Accordingly, the UE 115 may increment a preamble transmission counter (e.g., a PREAMBLE_TRANSMISSION_COUNTER parameter) by 1. If PREAMBLE_TRANSMISSION_COUNTER=preambleTransMax+1, where preambleTransMax is a threshold for the preamble transmission counter, and if the RACH preamble is transmitted on the SpCell, then the UE 115 may indicate a RACH problem to upper layers. Additionally, or alternatively, if the random access procedure was triggered for a system information (SI) request, then the UE 115 may consider the random access procedure to be unsuccessfully completed. If the RACH preamble is transmitted on an SCell, then the UE 115 may consider the random access procedure to be unsuccessfully completed.

In some examples, if the random access procedure is not completed, then the UE 115 may select a random backoff time according to a uniform distribution between 0 and the time indicated by a PREAMBLE_BACKOFF parameter. If a criteria to select contention-free RACH resources is met during the backoff time, then the UE 115 may perform a RACH resource selection procedure. Additionally of alternatively, if the random access procedure for an SCell is performed on an uplink carrier where pusch-Config is not configured, then the UE 115 may delay the subsequent RACH transmission until the random access procedure is triggered by a PDCCH order with the same ra-PreambleIndex, ra-ssb-OccasionMaskIndex, and UL/SUL indicator. Additionally or alternatively, the UE 115 may perform the RACH resource selection procedure after the backoff time.

In some examples, the UE 115 (e.g., a MAC entity) may, perform additional steps as part of the random access procedure. For instance, if PREAMBLE_TRANSMISSION_COUNTER is greater than one, if the UE 115 does not receive a notification of suspending a power ramping counter from lower layers, if the UE 115 does not receive a LFT failure indication from the lower layers for the last RACH preamble transmission, and if the UE 115 does not change an SSB or CSI-RS selection from the selection made in the last RACH preamble transmission, then the UE 115 may increment PREAMBLE_POWER_RAMPING_COUNTER by 1.

In some examples, the UE 115 may select a value of a DELTA_PREAMBLE. In some examples, the UE 115 may set PREAMBLE_RECEIVED_TARGET_POWER to a value based on Equation 1.

$$PREAMBLE\_RECEIVED \_TARGET \_POWER = preambleReceivedTarge t Power + DELTA\_PREAMBLE + ( PREAMBLE\_POWER \_RAMPING \_COUNTER - 1 ) \times PREAMBLE\_POWER \_RAMPING \_STEP + POWER\_OFFSET \_ 2 STEP\_RA \qquad Equation 1$$

In some examples, not including examples for a contention-free RACH preamble for a beam failure recovery request, the UE 115 may compute the RA-RNTI associated with the PRACH occasion in which the RACH preamble is transmitted. Additionally of alternatively, the UE 115 may instruct the physical layer to transmit the RACH preamble using the selected PRACH occasion, a corresponding RA-RNTI (if available), a PREAMBLE_INDEX, and a PREAMBLE_RECEIVED_TARGET_POWER.

In some cases, the RA-RNTI associated with the PRACH occasion in which the RACH preamble is transmitted may be computed as described in Equation 2.

$$R A - RNTI = 1 + s\_id + 14 \times t\_id + 14 \times 80 \times f\_id + 14 \times 80 \times 8 \times ul\_carrier \_id \qquad Equation 2$$

In Equation 2, s_id may be the index of the first OFDM symbol of the PRACH occasion (0≤s_id<14), and t_id may be the index of the first slot of the PRACH occasion in a system frame (0≤t_id<80). In some examples, the subcarrier spacing used by the UE 115 to determine t_id may be based on the value of u. Additionally, in Equation 2, f_id may be the index of the PRACH occasion in the frequency domain (0≤f_id<8), and ul_carrier_id may be the UL carrier used for a RACH preamble transmission (e.g., 0 for NUL carrier, and 1 for SUL carrier).

In some examples, the UE 115 may initiate a random access procedure based on a PDCCH order, by implementation of the UE 115 (e.g., of the MAC entity itself), or by a radio resource control (RRC) for the events of the random access procedure to occur. In some cases, the UE 115 (e.g., a MAC entity) may be capable of supporting one ongoing random access procedure at any point in time. In some examples, the random access procedure on an SCell may only be initiated by a PDCCH order with ra-PreambleIndex different from 0b000000. In some cases, if a new random access procedure is triggered while another is already ongoing in the MAC entity, the UE 115 may decide whether to continue with the ongoing procedure or start with the new procedure (e.g., for SI request). If an ongoing random access procedure was triggered by a PDCCH order while the UE 115 receives another PDCCH order indicating the same RACH preamble, PRACH mask index, and uplink carrier, then the UE 115 may consider the new random access procedure to be the same random access procedure as the ongoing one. Accordingly, the UE 115 may not perform initialization again.

In some examples, if the random access procedure is initiated on a serving cell, then the MAC entity shall perform one or more procedures. In some aspects, the UE 115 may flush the MSG. 3 buffer. Additionally, or alternatively, the UE 115 may flush the MSG. A buffer. The UE 115 may set the PREAMBLE_TRANSMISSION_COUNTER to 1. The UE 115 may set the PREAMBLE_POWER_RAMPING_COUNTER to 1. The UE 115 may set the PREAMBLE_BACKOFF to 0 ms. The UE 115 may set the POWER_OFFSET_2STEP_RA to 0 dB.

In some aspects, a UE 115 may support multiple parallel RACH procedures for multiple TRPs or for CCs (e.g., network entities 105) in different TAGs if one or more conditions are satisfied. For example, a UE 115 may support up to two parallel random access procedures for a same CC configured with two TAGs and two CORESET pool indices. In some examples, a UE 115 may support up to four parallel random access procedures for different CCs that are each associated with a different TAG. In some examples, a UE 115 may support up to four parallel random access procedures for different CCs across or within sets of CCs (e.g., may support two parallel RACH procedures in different sets of CCs defined by different TAGs, and may also support up to two parallel random access procedures within sets of CCs for one or two CCs if the two random access procedures are triggered by PDCCH orders associated with different CORESET pool indices). In some examples, the UE 115 may support up to four random access procedures for a same CC or different CCs if two random access procedures associated with a same CC have different CORESET pool indices, and additional random access procedures are associated with different CCs and different TAGS.

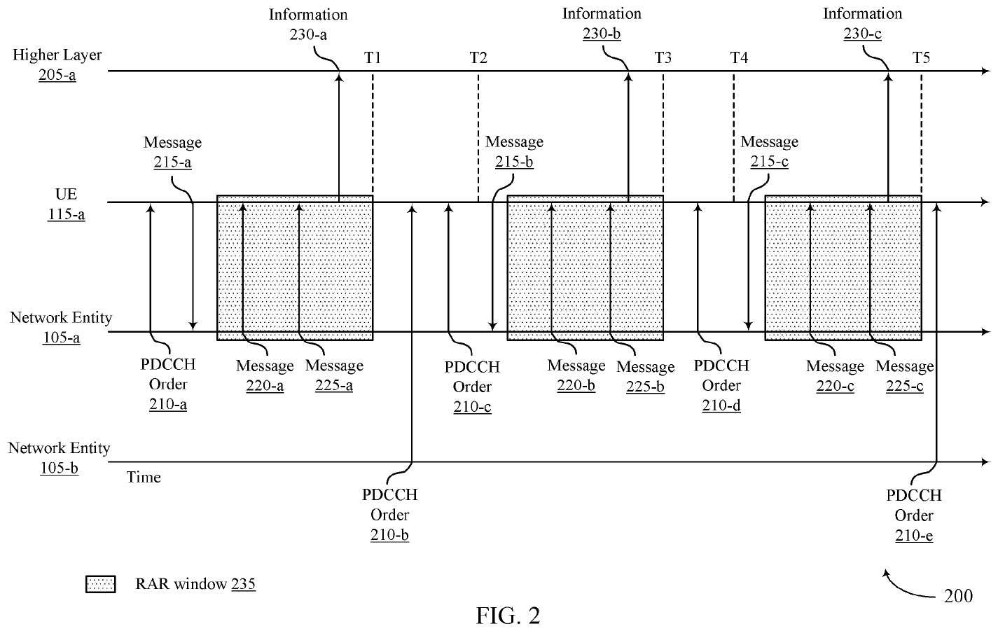

FIG. 2 illustrates an example of a timeline 200 that supports performing multiple parallel random access procedures in accordance with one or more aspects of the present disclosure. In some examples, the timeline 200 may be implemented by one or more aspects of the wireless communications system 100. For instance, a UE 115-a may be an example of a UE 115, and a network entity 105-a may be an example of a network entity 105, as described with reference to FIG. 1.

In some examples, the UE 115-a may perform a random access procedure to establish a connection with a network, such as a special cell (SpCell) served by a network entity 105-a, a network entity 105-b, or a different network entity. Additionally, or alternatively, the UE 115-a may perform the random access procedure to achieve uplink synchronization between the UE 115-a and the network. For example, the network entity 105-a (e.g., a transmission reception point) may transmit, and the UE 115-a may receive, a physical downlink control channel (PDCCH) order 210-a which may trigger the random access procedure. In some examples, the PDCCH order 210-a may indicate a RACH preamble identifier (e.g., a RAPID), which may also be referred to as a RACH preamble index. Based on receiving the PDCCH order 210-a, the UE 115-a may transmit (e.g., as part of the triggered random access procedure) a message 215-a (e.g., a RACH preamble (PRACH) transmission, such as a message 1 of a four-step random access procedure or message A of a two-step random access procedure) to the network entity 105-a. The message 215-a may include the RAPID, one or more RACH occasion, and other transmission related parameters. Based on transmitting the message 215-a, the UE 115-a may monitor for a random access response message (e.g., a random access response (RAR)) from the network (e.g., from the network entity 105-a, the network entity 105-b, or a different network entity) during a RAR window 235. For example, the network entity 105-a may transmit a message RAR to the UE 115-a. The RAR may include a PDCCH portion and a PDSCH portion. For instance, the RAR may include a message 220-a, which may include a PDCCH scrambled by a random access radio network temporary identifier (RA-RNTI). Additionally, or alternatively, the RAR may include a message 225-a, which may include a physical downlink shared channel (PDSCH).

In some examples, the UE 115-a may decode the message 220-a and the message 225-a at the physical layer of the UE 115-a. Based on decoding the message 220-a and the message 225-a, the UE 115-a may send information 230-a (e.g., the information received on the PDSCH via the message 225-a of a received RAR) to higher layer 205-a of the UE 115-a. For instance, based on decoding the message 220-a and the message 225-a, the UE 115-a may forward a transport block (TB) from the physical layer of the UE 115-a to a medium access control (MAC) layer (e.g., the higher layer 205-a). The information 230-a may include a RAPID received via the RAR. The higher layer 205-a may interpret the content of the information 230-a (e.g., may parse the transport block) to identify whether the RAPID in the information 230-a matches the RAPID from the message 215-a (e.g., the preamble transmitted by the UE 115-a). If the RAPID associated with the information 230-a is the same as the RAPID associated with the message 215-a, then the UE 115-a may determine that the random access procedure is successfully complete. Alternatively, if the RAPID associated with the information 230-a is not the same as the RAPID associated with the message 215-a, or if the UE 115-a does not successfully receive or decode the message 220-a, the message 225-a, or both, then the UE 115-a may continue monitoring for a RAR from the network during the RAR window 235 until the expiration of a timer. If the timer expires and the UE 115-a does not detect a PDSCH with the same RAPID as the RAPID associated with the message 215-a (e.g., the UE 115-a receives one or more RARs from other network entities 105, or receives a RAR from the network entity 105-a that is associated with a different random access procedure, or the UE 115-a does not successfully receive or decode the message 220-a and/or the message 225-a), then the random access procedure may be considered unsuccessful at T1. Upon initiating the random access procedure, the UE 115-a may set a preamble transmission counter to 1. Accordingly, if the random access procedure is considered to be unsuccessful at T1, then the UE 115-a may increment a preamble transmission counter by 1 so that the preamble transmission counter may equal 2.

If the random access procedure is unsuccessful, the network entity 105-a may trigger a RACH retransmission by repeating the procedure as described herein. The network entity 105-a may continue to trigger RACH retransmissions until the UE 115-a increments the preamble transmission counter to a threshold value. For instance, if the UE 115-a starts the random access procedure with the preamble transmission counter set at a value of 1, then the UE 115-a may complete three attempts to achieve a successful random access procedure until the threshold value of the preamble transmission counter is reached (e.g., at which point, the UE 115-a may consider the random access procedure unsuccessfully completed). Thus, if the UE 115-a or a network entity 105 configures the preamble transmission counter to have a threshold value of 4, then the UE 115-a may consider the random access procedure to be unsuccessfully completed if the UE 115-a increments the preamble transmission counter to the value of 4 after one RACH transmission and two RACH retransmissions.

For example, the network entity 105-a may transmit, and the UE 115-a may receive, a PDCCH order 210-c. In some examples, the UE 115-a may change a spatial domain transmission filter (e.g., may change a transmit beam) prior to a PRACH retransmission (e.g., before the UE 115-a transmits a message 215-b). Additionally, or alternatively, the physical layer of the UE 115-a may notify higher layers of the UE 115-a (e.g., the higher layer 205-a) to suspend a power ramping counter. Upon initiating the random access procedure, the UE 115-a may set the power ramping counter to 1. If prior to the PRACH retransmission, the UE 115-a does not change the spatial domain transmission filter, then the physical layer of the UE 115-a may notify higher layers (e.g., the higher layer 205-a) to increment the power ramping counter by 1 so that the UE 115-a may set the power ramping counter to 2. At T2, the UE 115-a may adjust a preamble received target power accordingly. To continue the RACH retransmission, the UE 115-a may transmit the message 215-b to the network entity 105-a. Based on receiving the message 215-b, the network entity 105-a may send a RAR during a second RAR window 235 by sending a message 220-b, a message 225-b, or both. After decoding the RAR, the physical layer of the UE 115-a may transmit information 230-b to the higher layer 205-a. If the RAPID from the RAR is different from the RAPID included in the message 215-b, then the UE 115-a may continue monitoring for a RAR during the RAR window 235 until the expiration of a timer. If the timer expires at T3 and the UE 115-a does not detect a PDSCH with the same RAPID as the RAPID associated with the message 215-b, then the UE 115-a may consider the random access procedure to be unsuccessful. Accordingly, if the random access procedure is considered to be unsuccessful, the UE 115-a may increment a preamble transmission counter by 1, setting the preamble transmission counter to 3.

In some examples, the UE 115-a may increment the power ramping counter by 1 and set the power ramping counter to 3 at T4. The network entity 105-a may transmit, and the UE 115-a may receive, a PDCCH order 210-d. In some examples, the UE 115-a may change the spatial domain transmission filter prior to the second PRACH retransmission (e.g., before the UE 115-a transmits a message 215-c). Additionally, or alternatively, the physical layer of the UE 115-a may notify the higher layer 205-a to suspend the power ramping counter. If the UE 115-a does not change the spatial domain transmission filter prior to the second PRACH retransmission, then the physical layer of the UE 115-a may notify the higher layer 205-a to increment the power ramping counter by 1 so that the UE 115-a may set the power ramping counter to 3. At T4, the UE 115-a may adjust a preamble received target power accordingly. To continue the second RACH retransmission, the UE 115-a may transmit the message 215-c to the network entity 105-a. Based on receiving the message 215-c, the network entity 105-a may send a RAR during a third RAR window 235 by sending a message 220-c, a message 225-c, or both. After decoding the RAR, the physical layer of the UE 115-a may transmit information 230-c to the higher layer 205-a. If the RAPID from the RAR is different from the RAPID included in the message 215-c, then the UE 115-a may continue monitoring for a RAR during the RAR window 235 until the expiration of a timer. If the timer expires and the UE 115-a does not detect a PDSCH with the same RAPID as the RAPID associated with the message 215-c, then the UE 115-a may consider the random access procedure to be unsuccessful, and the UE 115-a may increment a preamble transmission counter by 1 so that the preamble transmission counter may equal 4. If the UE 115-a or a network entity 105 configured the preamble transmission counter to have a threshold value of 4, then the UE 115-a may consider the random access procedure to be unsuccessfully completed at T5.

In some cases, a MAC entity (e.g., at the UE 115-a) may not be capable of performing multiple random access procedures in parallel. For instance, a serving cell may include multiple TRPs and may be associated with one or more (e.g., two) different timing advance groups (TAGs). In some examples, a first TRP may be associated with the network entity 105-a and a second TRP may be associated with the second network entity 105-b. Additionally or alternatively, a first TAG may include the first TRP and a second TAG may include the second TRP. Because the first and second TRPs may be associated with different TAGs, uplink communication between the first and second TRPs and the UE 115-a may be non-synchronous. When uplink communication is non-synchronous from UE 115-a to the first and second TRPs in the serving cell, a random access procedure for the second TRP may be restricted to being performed by the UE 115-a once the random access procedure for the first TRP is completed. In other words, the uplink synchronization for the second TRP may not begin until the uplink synchronization for the first TRP is completed. In some cases, the UE 115-a may not be capable of performing multiple random access procedures in parallel for carrier aggregation scenarios. For instance, a serving cell may be associated with a first component carrier and a second serving cell may be associated with a second component carrier. The component carriers may be associated with different TAGs. Accordingly, a UE 115-c may not be capable of performing a random access procedure for the second serving cell associated with a second TAG until a random access procedure for the first serving cell associated with a first TAG is completed. Because the UE 115-a may not be capable of performing multiple random access procedures in parallel, the wireless communication network may experience additional delay for uplink synchronization of the TRPs or component carriers in order to establish timing alignment for the TRPs or component carriers.

For example, if the network entity 105-b triggers a second random access procedure by sending a PDCCH order 210-b during the initial random access procedure which was triggered by the network entity 105-a, then the UE 115-a may determine whether to continue with the initial random access procedure and ignore the second random access procedure, or end the initial random access procedure and start the second random access procedure. In other words, if the UE 115-a decides to continue with the ongoing random access procedure initiated by the network entity 105-a, then the UE 115-a may not have the capability to support another random access procedure at the same time. If the initial random access procedure is unsuccessfully completed at T5, then the UE 115-a may support the second random access procedure at T5 after the network entity 105-b triggers the second random access procedure by sending a PDCCH order 210-e. Additionally or alternatively, if the initial random access procedure is successfully completed (e.g., if the UE 115-a determines that the RAPID associated with the information 230-b is the same as the RAPID associated with the message 215-b), then the UE 115-a may support the second random access procedure. Accordingly, the network entity 105-b may not be able to initiate the second random access procedure until after the initial random access procedure is successfully or unsuccessfully completed.

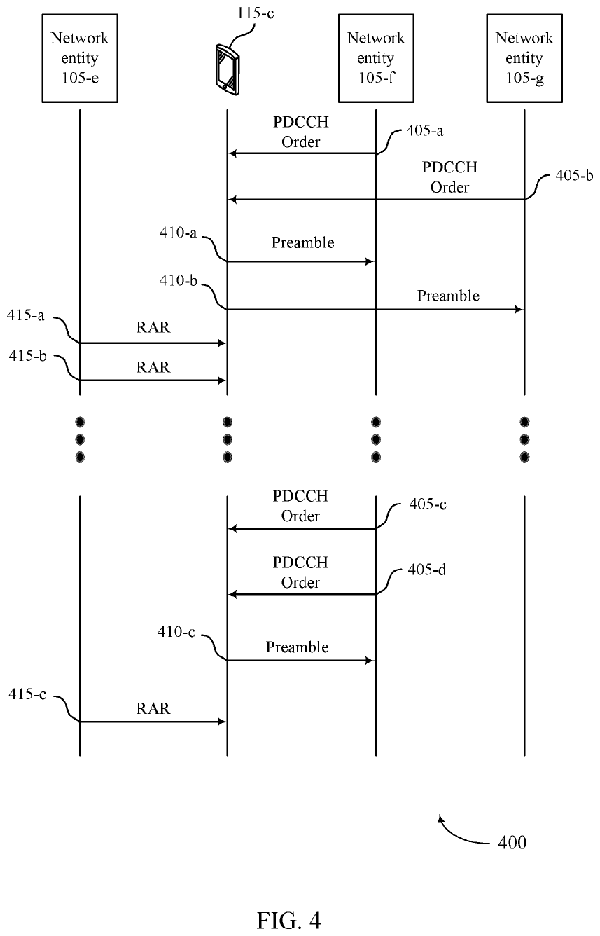

In some examples, as described in greater detail with reference to FIGS. 4-7, a UE 115-a may be capable of supporting multiple parallel random access procedures, instead of weighting to initiate a second random access procedure until after a first random access procedure has been successfully or unsuccessfully completed.

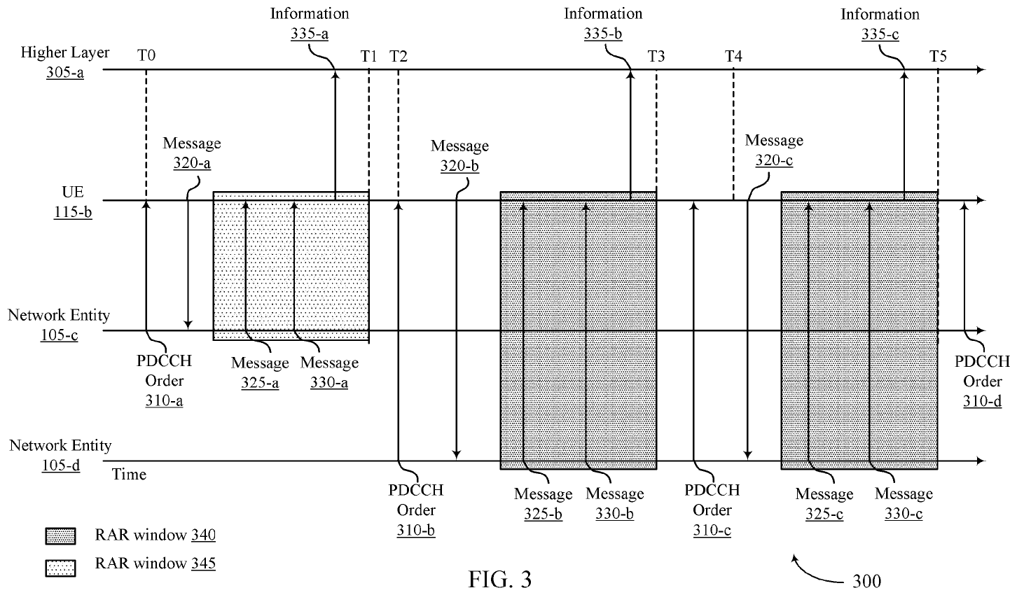

FIG. 3 illustrates an example of a timeline 300 that supports performing multiple parallel random access procedures in accordance with one or more aspects of the present disclosure. In some examples, the timeline 300 may be implemented by one or more aspects of the wireless communications system 100. For instance, a UE 115-b may be an example of a UE 115, and a network entity 105-c may be an example of a network entity 105, as described with reference to FIG. 1. In some examples, the UE 115-b may initiate a second random access procedure while performing a first ongoing random access procedure by terminating the first ongoing random access procedure.

A higher layer 305-a of the UE 115-b may start a random access procedure, and may initiate a preamble transmission counter and a power ramping counter at TO. The counters may be associated with the UE 115-b. In some examples, the UE 115-a may set the preamble transmission counter 1 and may set the power ramping counter to 1. To trigger a first random access procedure, the network entity 105-c (e.g., a TRP) may transmit, and the UE 115-b may receive, a PDCCH order 310-a. In some examples, the PDCCH order 310-a may indicate a RAPID, which may also be referred to as a RACH preamble index. Based on receiving the PDCCH order 310-a, the UE 115-b may transmit (e.g., as part of the triggered random access procedure) a message 320-a (e.g., a RACH preamble (PRACH) transmission, such as a message 1 of a four-step random access procedure or a message A of a two-step random access procedure) to the network entity 105-c. The message 320-a may include the RAPID, a RACH occasion, and other transmission related parameters. Based on transmitting the message 320-a, the UE 115-b may monitor for a random access response message (e.g., a RAR) from the network (e.g., from the network entity 105-c, the network entity 105-d, or a different network entity) during a RAR window 340. For example, the network entity 105-c may transmit a RAR message to the UE 115-b. The RAR may include a PDCCH portion and a PDSCH portion. For instance, the RAR may include a message 325-a, which may include a PDCCH scrambled by a random access radio network temporary identifier (RA-RNTI). Additionally, or alternatively, the RAR may include a message 330-a, which may include a physical downlink shared channel (PDSCH).

In some examples, the UE 115-b may decode the message 325-a and the message 330-a at the physical layer of the UE 115-b. Based on decoding the message 325-a and the message 330-a, the UE 115-b may send information 335-a (e.g., the information received on the PDSCH via the message 325-a of a received RAR) to higher layer 205-a of the UE 115-b. For instance, based on decoding the message 325-a and the message 330-a, the UE 115-b may forward a TB from the physical layer of the UE 115-b to a medium access control (MAC) layer (e.g., the higher layer 205-a). The information 335-a may include a RAPID received via the RAR. The higher layer 205-a may interpret the content of the information 335-a (e.g., may parse the TB) to identify whether the RAPID in the information 335-a matches the RAPID from the message 320-a (e.g., the preamble transmitted by the UE 115-b). If the RAPID associated with the information 335-a is the same as the RAPID associated with the message 320-a, then the UE 115-b may determine that the random access procedure is successfully complete. Alternatively, if the RAPID associated with the information 335-a is not the same as the RAPID associated with the message 320-a, or if the UE 115-b does not successfully receive or decode the message 325-a, the message 330-a, or both, then the UE 115-b may continue monitoring for a RAR from the network during the RAR window 340 until the expiration of a timer. If the timer expires and the UE 115-b does not detect a PDSCH with the same RAPID as the RAPID associated with the message 320-a (e.g., the UE 115-b receives one or more RARs from other network entities 105, or receives a RAR from the network entity 105-c that is associated with a different random access procedure, or the UE 115-b does not successfully receive or decode the message 325-a and/or the message 330-a), then the random access procedure may be considered unsuccessful at T1. Accordingly, if the random access procedure is considered to be unsuccessful at T1, then the UE 115-b may increment the preamble transmission counter by 1, setting the preamble transmission counter to 2.

In some cases, the network entity 105-d may initiate a second random access procedure during the first ongoing random access procedure by terminating the first ongoing random access procedure. For example, the network entity 105-d may transmit, and the UE 115-b may receive, a PDCCH order 310-b to trigger the second random access procedure. Based on receiving the PDCCH order 310-b, the UE 115-b may end the first ongoing random access procedure in order to begin the second random access procedure at T2. The UE 115-b may set the preamble transmission counter to 1. Additionally, or alternatively, the UE 115-b may set the power ramping counter to 1. To continue performing the second random access procedure, the UE 115-b may transmit the message 320-b to the network entity 105-d. Based on receiving the message 320-b, the network entity 105-d may send a RAR during a second RAR window 345 (e.g., the network entity 105-d may send a message 325-b and a message 330-b). After decoding the RAR, the physical layer of the UE 115-b may transmit information 335-b to the higher layer 305-a. If the RAPID from the RAR is different from the RAPID included in the message 320-b, then the UE 115-b may continue monitoring for a RAR during the RAR window 345 until the expiration of a timer. If the timer expires at T3 and the UE 115-b does not detect a PDSCH with the same RAPID as the RAPID associated with the message 320-b, then the UE 115-b may consider the random access procedure to be unsuccessful. Accordingly, the UE 115-b may increment the preamble transmission counter by 1 at T3, setting the preamble transmission counter to 2.

In some examples, the UE 115-b may change a spatial domain transmission filter (e.g., may change a transmit beam) prior to a PRACH retransmission (e.g., before the UE 115-b transmits a message 320-c). Additionally, or alternatively, the physical layer of the UE 115-b may notify higher layers of the UE 115-b (e.g., the higher layer 305-a) to suspend the power ramping counter. In other examples, the UE 115-b may increment the power ramping counter by 1 to set the power ramping counter to 2 at T4. Accordingly, the UE 115-b may adjust the preamble received target power.

Because the UE 115-b may consider the random access procedure to be unsuccessful, the network entity 105-d may trigger a RACH retransmission by repeating the procedure as described herein. The network entity 105-d may continue to trigger RACH retransmissions until the UE 115-a increments the preamble transmission counter to a threshold value or until the UE 115-a determines that the RAPID indicated by the RAR matches the RAPID indicated by message A of the second random access procedure. For instance, the network entity 105-d may transmit, and the UE 115-b may receive, a PDCCH order 310-c. Additionally, the UE 115-b may transmit the message 320-c to the network entity 105-d. Based on receiving the message 320-c, the network entity 105-d may send a RAR during a third RAR window 345 by sending a message 325-c, a message 330-c, or both. After decoding the RAR, the physical layer of the UE 115-b may transmit information 335-c to the higher layer 305-a. If the RAPID associated with the information 335-c is the same as the RAPID associated with the message 320-c, then the UE 115-b may consider the second random access procedure to be successful at T5. Accordingly, the UE 115-b may support a new random access procedure after T5. For instance, if the network entity 105-c may trigger a new random access procedure by sending a PDCCH order 310-d to the UE 115-b after T5. Accordingly, the network entity 105-d may not be able to initiate the new random access procedure until the UE 115-b considers the first and second random access procedures to be successfully or unsuccessfully completed, respectively.

In some examples, as described in greater detail with reference to FIGS. 4-7 one or more UEs may support multiple parallel random access procedures (e.g., random access procedures that at least partially overlap in time) if one or more conditions are satisfied.

FIG. 4 illustrates an example of a process flow 400 that supports performing multiple parallel random access procedures in accordance with one or more aspects of the present disclosure. In some examples, the process flow 400 may implement one or more aspects of the wireless communications system 100. For instance, a UE 115-c may be an example of a UE 115 as described with reference to FIG. 1. Additionally, or alternatively, a network entity 105-e, 105-f, and 105-g may each be an example of a network entity 105 as described with reference to FIG. 1.

In some examples, a UE (e.g., the UE 115-c) may support multiple parallel random access procedures ongoing at any point in time in a MAC entity if one or more conditions are satisfied. For example, for two random access procedures associated with the same component carrier, but different TAGs, the UE 115-c may support multiple (e.g., up to two) ongoing random access procedures if a control message used to trigger each random access procedure is associated with a different CORESET pool index. For example, if a first random access procedure and a second random access procedure are associated with a first component carrier which is associated with a first TAG and a second TAG, then the UE 115-c may determine to support the random access procedures simultaneously under the condition that a first CORESET pool index of a PDCCH order included in a first control message received at 405-a is different from a second CORESET pool index of a PDCCH order included in a second control message received at 405-b.

In some examples, the UE 115-c may receive signaling indicating a configuration associated with the network. For instance, the signaling may indicate a configuration of a first component carrier associated with a first TAG and a second TAG. Additionally, or alternatively, the signaling may indicated that a first random access procedure and a second random access procedure may be associated with the first component carrier. In some examples, a first TRP may be associated with the network entity 105-f and a second TRP may be associated with the network entity 105-g. Accordingly, the signaling may indicate that the first TRP and the second TRP are associated with the first component carrier and the different TAGs, respectively. The first and second TRPs may receive or utilize (e.g., from an SpCell or an SCell), resources for performing communications with the UE 115-c. In some examples, the UE 115-c may transmit a capability message to the network (e.g., via one or more network entities 105). The capability message may indicate that the UE 115-c is capable of supporting multiple random access procedures that at least partially overlap in time. The capability message may include an indication of a threshold number of random access procedures that at least partially overlap in time that the UE is capable of supporting, an indication of one or more conditions under which the UE 115-c is capable of supporting the random access procedures that at least partially overlap in time, or a combination thereof. In some examples, the UE 115-c may receive multiple PDCCH orders triggering parallel random access procedures based on having transmitted the capability message.

At 405-a, the network entity 105-f may transmit, and the UE 115-c may receive, a PDCCH order in a first control message triggering a first random access procedure (e.g., a contention free random access procedure). The PDCCH order received at 405-a may be associated with the first CORESET pool index. In some examples, the network entity 105-g may transmit, and the UE 115-c may receive, the PDCCH order at 405-b in a second control message triggering a second contention-free random access procedure. The PDCCH order received at 405-b may be associated with the second CORESET pool index.

Based on receiving the first control message including the PDCCH order received at 405-a, the UE 115-c may transmit, and the network entity 105-f may receive, a first RACH preamble associated with the first random access procedure at 410-a (e.g., using a first beam). Because the PDCCH order received at 405-a included in the first control message and the PDCCH order received at 405-b included in the second control message may each be associated with different CORESET pool indices, the UE 115-c may determine that a condition for performing the first and second random access procedures simultaneously is satisfied. Accordingly, based on receiving the second control message containing the PDCCH order at 405-b, the UE 115-c may transmit, and the network entity 105-g may receive, a second RACH preamble at 410-b (e.g., using a second beam). The second RACH preamble may be associated with the second random access procedure. The UE 115-c may transmit the second random access preamble at 410-b prior to completion of the first random access procedure. In some examples (e.g., as part of the two parallel random access procedures), the UE 115-c may receive a RAR at 415-a (e.g., associated with the first random access procedure and the preamble transmitted at 410-a) and a RAR at 415-b (e.g., associated with the second random access procedure and the preamble transmitted at 410-b). In some examples, the UE 115-a may receive the first and second RARs (e.g., at 415-a and at 415-b) via an SpCell. In some examples, the UE 115-a may receive the first and second RARs from a network entity 105-e. The network entity 105-e may be a different network entity (e.g., a different TRP) than the network entity 105-f and the network entity 105-g. In some examples, the network entity 105-e and the network entity 105-f may be the same network entity 105, or may be collocated with each other. In some examples, the network entity 105-e and the network entity 105-g may be the same network entity 105, or may be collocated with each other.

In some examples the UE 115-c may determine whether to refrain from initiating the new random access procedure, or initiate the new random access procedure while terminating the ongoing random access procedure (e.g., based on the condition that a control message that triggers a random access procedure is associated with the same CORESET pool index as the control message used to trigger an ongoing random access procedure). For example, the network entity 105-f may transmit, and the UE 115-c may receive, a first control message including a PDCCH order at 405-c that triggers a first random access procedure. Prior to the completion of the first random access procedure, the network entity 105-f may transmit, and the UE 115-c may receive, a second control message including a PDCCH order at 405-d that triggers a second random access procedure. Based on receiving the first control message, the UE 115-c may transmit, and the network entity 105-f may receive, a random access preamble at 410-c associated with the first random access procedure. The UE 115-c may determine that PDCCH order received at 405-d is associated with the same CORESET pool index value as the PDCCH order received at 405-c. In such examples, the UE 115-c may not support two simultaneous random access procedures. In such examples, the UE 115-c may either abandon the first random access procedure and initiate a second random access procedure associated with the PDCCH order received at 405-d, or may ignore the second random access procedure and continue with the first random access procedure (e.g., may transmit random access preamble at 410 associated with the first random access procedure, and receive a RAR at 415-c from a network entity such as the network entity 105-e).

In some examples, the first PDCCH order received at 405-c and the second PDCCH order received at 405-d may be associated with a same set of parameter values (e.g., a same CORESET pool index value, a same RACH preamble, a same PRACH mask index, a same uplink carrier, etc.). In such examples, the UE 115-c may consider the second random access procedure to be the same as the first random access procedure (e.g., and that the random access procedure has not been initialized again).

The UE 115-c may be able to support up to a threshold number (e.g., two) of parallel random access procedures, if the one or more conditions are satisfied, as described herein. In some examples, the UE 115-c may receive (e.g., from a network entity 105) a PDCCH order that exceeds the threshold (e.g., a third PDCCH order), and may refrain from initiating the additional random access procedure in parallel based on the new PDCCH order exceeding the threshold number of parallel random access procedures.

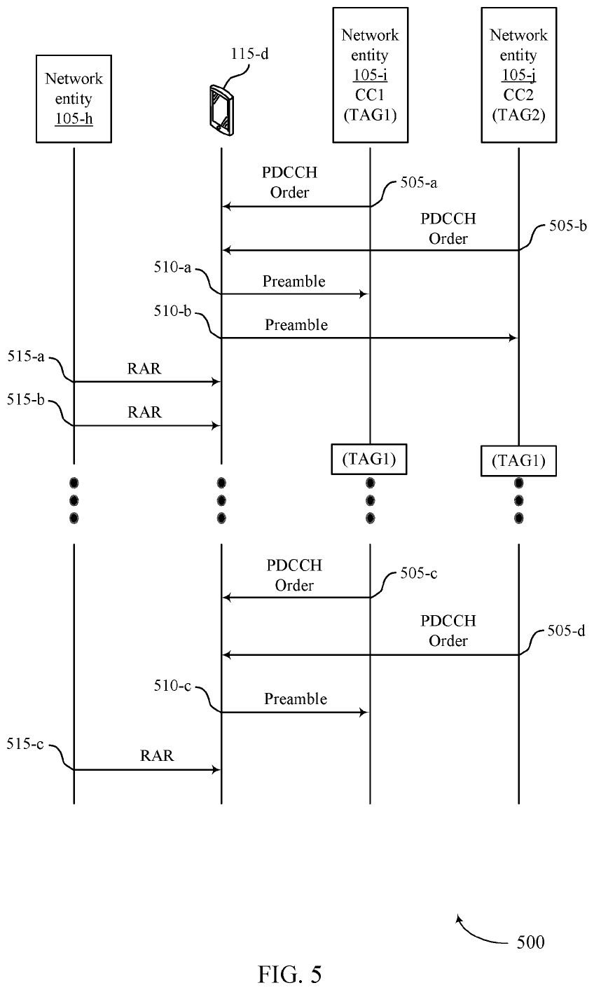

FIG. 5 illustrates an example of a process flow 500 that supports performing multiple parallel random access procedures in accordance with one or more aspects of the present disclosure. Process flow 500 may include a UE 115-d, and one or more network entities 105 (e.g., the network entity 105-i, the network entity 105-j, and the network entity 105-h), which may be examples of corresponding devices described with reference to FIGS. 1-4. In some examples, the network entity 105-i and the network entity 105-j may be different network entities 105 (e.g., different TRPs), or may be a same network entity 105 or collocated network entities 105 (e.g., a single network entity 105 operating on CC1 and CC2 in a carrier aggregation configuration). In some examples, the network entity 105-h may be a different network entity than the network entity 105-i and the network entity 105-j. In some examples, the network entity 105-h may be a same network entity or be collocated with one or both of the network entity 105-i and the network entity 105-j.

In some examples, as illustrated with reference to FIG. 5, one or more network entities 105 may trigger multiple random access procedures for different CCs (e.g., CC1 and CC2), and each CC may be configured with a single TAG. The UE 115-d may support a threshold number (e.g., four) of ongoing random access procedures at any point in time by its MAC entity. The UE 115-d may initiate a first random access procedure (e.g., a first CFRA procedure) triggered by a first PDCCH order for CC1 associated with TAG1. The UE 115-d may also receive a second PDCCH order triggering another random access procedure for CC2 associated with the TAG2 (e.g., which is different from TAG1). In such examples, the UE 115-d may support both ongoing random access procedures.

The UE 115-c may receive (e.g., from a network entity 105) signaling (e.g., configuration information such as RRC signaling, system information, or the like) indicating a configuration of a first TAG (e.g., TAG1) associated with a first CC (e.g., CC1) and a second TAG (e.g., TAG2) associated with a second CC (e.g., CC2). A first random access procedure may be associated with CC1, and a second random access procedure may be associated with CC2. At 505-a, the UE 115-d may receive a first PDCCH order (e.g., from a first network entity 105-i associated with CC1 and TAG1) triggering a first random access procedure. The UE 115-d may also receive (e.g., prior to completion of the first random access procedure) a second PDCCH order (e.g., from the first network entity 105-i or from a second network entity 105-j) triggering a second random access procedure. The second PDCCH order received at 505-b may be associated with CC2 and TAG2.

In some examples, the UE 115-d may transmit a capability message to the network (e.g., via one or more network entities 105). The capability message may indicate that the UE 115-d is capable of supporting multiple random access procedures that at least partially overlap in time. The capability message may include an indication of a threshold number of random access procedures that at least partially overlap in time that the UE 115-d is capable of supporting, an indication of one or more conditions under which the UE 115-d is capable of supporting the random access procedures that at least partially overlap in time, or a combination thereof. In some examples, the UE 115-d may receive multiple PDCCH orders triggering parallel random access procedures based on having transmitted the capability message.

The UE 115-d may determine that the one or more conditions are satisfied if TAG1 associated with CC1 (e.g., and the first PDCCH order received at 505-a) is different than TAG 2 associated with CC2 (e.g., and the second PDCCH order received at 505-b). Because the TAGs of the two CCs triggered by the two PDCCH orders are different, the UE 115-d may support multiple (e.g., up to four) parallel random access procedures. In such examples, the UE 115-d may transmit a random access preamble for the first random access procedure (e.g., to the network entity 105-i using a first beam) at 510-a, and may transmit a second preamble for the second random access procedure (e.g., to the network entity 105-j using a second beam) at 510-b, prior to expiration of the first random access procedure. The UE 115-d may transmit the first preamble at 510-a using a first beam, and may transmit the second preamble at 510-b using a second beam. At 515-a, the UE 115-d may receive a first RAR associated with the first random access procedure (e.g., via an SpCell). At 515-b, the UE 115-d may receive a second RAR associated with the second random access procedure (e.g., via an SpCell). The UE 115-d may receive one or both of the first RAR and the second RAR via the network entity 105-h (e.g., or any other network entity, such as the network entity 105-i and the network entity 105-j).

The UE 115-d may not support multiple parallel random access procedures if the multiple random access procedures do not satisfy the one or more conditions. For instance, the UE 115-d may not support parallel random access procedures if an ongoing random access procedure for CC1 associated with TAG triggered by a first PDCCH order is interrupted by a second PDCCH order triggering another random access procedure for CC2 associated with a second TAG that is the same as the first TAG (e.g., TAG1). For example, at 505-c, the UE 115-d may receive a first PDCCH order at 505-c triggering a first random access procedure for CC1 associated with TAG1. At 505-d, prior to completion of the first random access procedure, the UE 115-d may receive a second PDCCH order for CC2 associated with TAG1. Because the TAGs of the first CC and the second CC triggered by the first PDCCH order and the second PDCCH order are the same, the UE 115-d may refrain from initiating a second random access procedure prior to completion of the first random access order.

The UE may determine (e.g., autonomously by UE implementation) whether to continue the ongoing random access procedure or to start with the new random access procedure. In some examples, the UE 115-d may continue the current (e.g., first) random access procedure for the SpCell (e.g., Pcell or PScell) if one of CC1 and CC2 is the SpCel, and may stop the current random access procedure for another CC. In some examples, the UE 115-d may continue the current random access procedure for a lower CC (e.g., CC1) and may stop the random access procedure for higher CCs (e.g., CC2). For example, the UE 115-d may transmit random access preamble at 510-c (e.g., to the network entity 105-i) for the first random access procedure (e.g., but may not initiate the second random access procedure). At 515-c, the UE 115-d may receive a RAR (e.g., via an SpCell). The UE 115-d may, in some examples, receive the RAR at 515-c from a network entity 105-h (e.g., which may be the same network entity 105 as or a different network entity 105 from one or both of the network entity 105-i and the network entity 105-j).

The UE 115-d may be able to support up to a threshold number (e.g., four) of parallel random access procedures, if the one or more conditions are satisfied, as described herein. In some examples, the UE 115-d may receive (e.g., from a network entity 105) a PDCCH order that exceeds the threshold (e.g., a fifth PDCCH order), and may refrain from initiating the additional random access procedure in parallel based on the new PDCCH order exceeding the threshold number of parallel random access procedures.

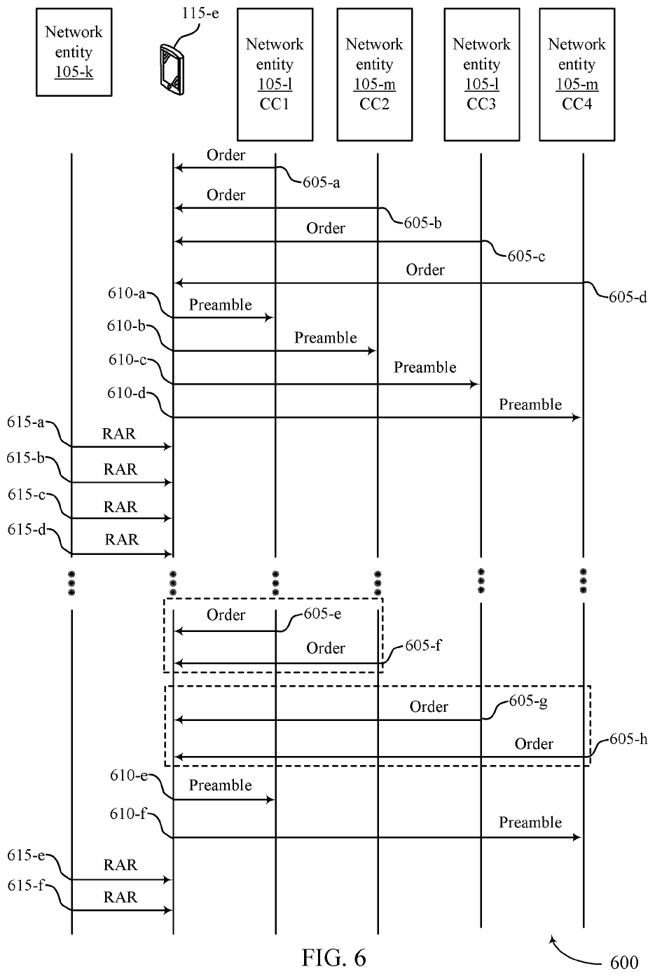

FIG. 6 illustrates an example of a process flow 600 that supports performing multiple parallel random access procedures in accordance with one or more aspects of the present disclosure. Process flow 600 may include a UE 115-e, and one or more network entities 105 (e.g., the network entity 105-1, the network entity 105-m, and the network entity 105-k), which may be examples of corresponding devices described with reference to FIGS. 1-5. In some examples, the network entity 105-1 and the network entity 105-m may be different network entities 105 (e.g., different TRPs), or may be a same network entity 105 or collocated network entities 105 (e.g., a single network entity 105 operating on CC1 and CC2 in a carrier aggregation configuration). In some examples, the network entity 105-h may be a different network entity than the network entity 105-i and the network entity 105-j. In some examples, the network entity 105-h may be a same network entity or be collocated with one or both of the network entity 105-i and the network entity 105-j.

In some examples, the UE 115-e may transmit a capability message to the network (e.g., via one or more network entities 105). The capability message may indicate that the UE 115-e is capable of supporting multiple random access procedures that at least partially overlap in time. The capability message may include an indication of a threshold number of random access procedures that at least partially overlap in time that the UE 115-e is capable of supporting, an indication of one or more conditions under which the UE 115-e is capable of supporting the random access procedures that at least partially overlap in time, or a combination thereof. In some examples, the UE 115-e may receive multiple PDCCH orders triggering parallel random access procedures based on having transmitted the capability message.

In some examples, one or more network entities 105 may trigger multiple random access procedures for a same CC or different CCs, where at least one CC is configured with two TAGs. For example, the UE 115-e may receive (e.g., from a network entity) signaling (e.g., RRC signaling, system information, dynamic signaling, etc.) indicating a configuration of a first set of CCs (e.g., CC1 and CC2) and a second set of CCs (e.g., CC3 and CC4). Each CC of the first set of CCs may be associated with one or more TAGS of a first set of TAGs, and each CC of the second set of CCs may be associated with one or more TAGs of a second set of TAGs. In such examples, the UE 115-e may support a threshold number (e.g., four) of parallel ongoing random access procedures at any point in time at its MAC entity if one or more conditions are satisfied. For example, the UE 115-e may receive a first PDCCH order triggering an ongoing random access procedure for a first CC belonging to the first set of CCs (e.g., CC1). The UE 115-e may receive a second PDCCH order triggering another random access procedure (e.g., a CFRA procedure) for a second CC belonging to the second set of CCs (e.g., CC3). In such example, the UE 115-e may determine that the one or more conditions are satisfied if CC1 belongs to the first set of CCs, and CC3 belongs to the second set of CCs. For example, the sets of CCs may be determined based on TAGs (e.g., different sets of TAGs associated with the CCs of each set of CCs). The UE 115-e may support parallel random access procedures for CCs in different sets of CCs.

For example, the UE may receive a first PDCCH order triggering a first random access procedure for CC1 of the first set of CCs at 605-a (e.g., from the network entity 105-1). At 605-c, the UE 115-e may receive a second PDCCH order triggering a second random access procedure for CC3 of the second set of CCs (e.g., from the network entity 105-1). Because the CCs are different, because the CCs belong to different CC sets, or both, the UE 115-e may support both the first random access procedure and the second random access procedure. In such examples, the UE 115-e may transmit a random access preamble associated with the first random access procedure at 605-a (e.g., to the network entity 105-1) and may transmit a second random access preamble associated with the second random access procedure at 605-c (e.g., to the network entity 105-1). Similarly, the UE 115-e may receive a first RAR at 615-a for the first random access procedure via an SpCell (e.g., from the network entity 105-k) and may receive a second RAR at 615-c for the second random access procedure via the SpCell (e.g., from the network entity 105-k). Thus, the UE 115-e may support parallel random access procedures across different sets of CCs.

In some examples, the UE 115-e may also support parallel random access procedures within sets of CCs. For instance, the UE 115-e may perform an ongoing random access procedure triggered for a first CC belonging to the first set of CCs triggered by a first PDCCH order associated with a first CORESET pool index. The UE 115-e may also receive, prior to completion of the ongoing random access procedure, a second PDCCH order triggering another random access procedure for a second CC belong to the same set of CCs as the first CC having a different CORESET pool index. The first CC and the second CC within the set of CCs may be the same CC or different CCs. In such examples, the UE 115-e may determine that the one or more conditions are satisfied if the CORESET pool indices of the two PDCCH orders associated with the same set of CCs are different.

For example, the UE 115-e may receive, a PDCCH order triggering a third random access procedure for CC2 of the first set of CCs at 605-b (e.g., from the network entity 105-m) prior to completion of the first random access procedure triggered at 605-a. The CORESET pool index of the first PDCCH order received at 605-a (e.g., CORESETPoolindex 0) may be different than the CORESET pool index of the third PDCCH order received at 605-b (e.g., CORESETPoolindex 1). Because the CORESET pool index of the PDCCH order received at 605-a and the COREST pool index of the PDCCH order received at 605-b are different, the UE 115-e may support the two parallel random access procedures. Similarly, if the UE receives a fourth PDCCH order triggering a fourth random access procedure associated with CC4 of the second set of CCs (e.g., from the network entity 105-m prior to expiration of the random access procedure triggered at 605-c), the UE 115-e may support parallel random access procedures for random access procedures triggered at 605-c and 605-d if the CORESET pool indices of the PDCCH order are different.

In such examples, the UE 115-e may support a first random access procedure triggered at 605-a and a second random access procedure triggered at 605-c if the two random access procedures are associated with CCs in different CC sets (e.g., CC1 of the first set of CCs and CC3 of the second set of CCs). Additionally, or alternatively, the UE 115-e may also support parallel random access procedures triggered at 605-a and 605-b, and parallel random access procedures triggered at 605-c and 605-d, if the CORESET pool indices of random access procedures triggered for a same set of CCs are different. In such examples, the UE 115-e may support up to four parallel random access procedures. In such examples, the UE 115-e may transmit random access preambles for the four respective random access procedures at 610-a (e.g., using a first beam), 610-b (e.g., using a second beam), 610-c (e.g., using the first beam), and 610-d (e.g., using the second beam), respectively, and may receive RARs at 615-a, 615-b, 615-c, and 615-d, respectively.

The UE 115-e may not support parallel random access procedures at the same instance in time if the one or more conditions are not satisfied. For example, the UE 115-e may perform an ongoing random access procedure for a first CC belonging to a first set of CCs triggered by a first PDCCH order associated with a first CORESET pool index value. The UE 115-e may receive a second PDCCH order associated with a second CORESET pool index that is the same as the first CORESET pool index value triggering a second random access procedure for a second CC belonging to the same set of CCs as the first CC. In such examples, the UE 115-e may not support both random access procedures in parallel (e.g., overlapping at least partially in time). For example, CCs may be divided into sets of CCs, and each set of CCs may be configured with different TAGs (e.g., each of the first set of CCs may be associated with one or both of TAG1 and TAG2, and each of the second set of CCs may be associated with one or both of TAG3 and TAG4).

For example, at 605-e, the UE 115-e may receive a PDCCH order triggering a first random access procedure for CC1 in the first set of CCs. At 605-f (e.g., prior to completion of the first random access procedure), the UE 115-e may receive a second PDCCH order triggering a second random access procedure for CC1 or CC2 of the first set of CCs. If both the first PDCCH order and the second PDCCH order are associated with a same CORESET pool index (e.g., CORESETPoolindex0), then the UE 115-e may not support both the first random access procedure and the second random access procedure. Similarly, at 605-g, the UE 115-e may receive a third PDCCH order triggering a random access procedure for CC3 in the second set of CCs.

At 605-h (e.g., prior to completion of the third random access procedure, the first random access procedure, or both), the UE 115-e may receive a fourth PDCCH order triggering a random access procedure for CC3 or CC4 of the second set of CCs. If both the third PDCCH order and the fourth PDCCH order are associated with a same CORESET pool index (e.g., CORESETPoolindex 1), then the UE 115-e may not support both the third random access procedure and the fourth random access procedure in parallel (e.g., overlapping at least partially in time). Thus, the UE 115-e may support one random access procedure associated with the first set of CCs (e.g., the first random access procedure triggered at 605-e), and one random access procedure associated with the second set of CCs (e.g., the fourth random access procedure triggered at 605-h), but may not support the second random access procedure or the third random access procedure. In such examples, the UE 115-e may transmit a first random access preamble associated with the first random access procedure at 610-e (e.g., to the network entity 105-1) and may transmit a second random access preamble associated with the fourth random access procedure at 610-f (e.g., to the network entity 105-m). At 615-e, the UE 115-e may receive a first RAR associated with the first random access procedure via an SpCell (e.g., from the network entity 105-k). At 615-f, the UE 115-e may receive a second RAR associated with the fourth random access procedure via the SpCell (e.g., from the network entity 105-k).

The UE 115-e may be able to support up to a threshold number (e.g., four) of parallel random access procedures, if the one or more conditions are satisfied, as described herein. In some examples, the UE 115-e may receive (e.g., from a network entity 105) a PDCCH order that exceeds the threshold (e.g., a fifth PDCCH order), and may refrain from initiating the additional random access procedure in parallel based on the new PDCCH order exceeding the threshold number of parallel random access procedures.

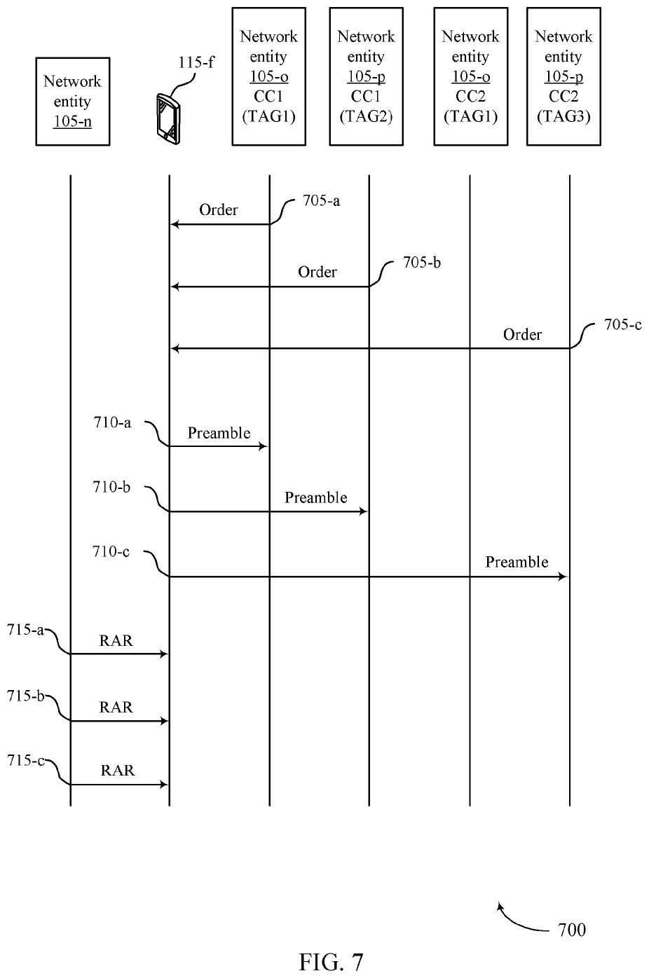

FIG. 7 illustrates an example of a process flow 700 that supports performing multiple parallel random access procedures in accordance with one or more aspects of the present disclosure. Process flow 700 may include a UE 115-f, and one or more network entities 105 (e.g., the network entity 105-n, the network entity 105-0, and the network entity 105-p), which may be examples of corresponding devices described with reference to FIGS. 1-6. In some examples, the network entity 105-o and the network entity 105-p may be different network entities 105 (e.g., different TRPs), or may be a same network entity 105 or collocated network entities 105 (e.g., a single network entity 105 operating on CC1 and CC2 in a carrier aggregation configuration). In some examples, the network entity 105-n may be a different network entity than the network entity 105-o and the network entity 105-p. In some examples, the network entity 105-n may be a same network entity or be collocated with one or both of the network entity 105-o and the network entity 105-p.

In some examples, the UE 115-f may transmit a capability message to the network (e.g., via one or more network entities 105). The capability message may indicate that the UE 115-f is capable of supporting multiple random access procedures that at least partially overlap in time. The capability message may include an indication of a threshold number of random access procedures that at least partially overlap in time that the UE 115-f is capable of supporting, an indication of one or more conditions under which the UE 115-f is capable of supporting the random access procedures that at least partially overlap in time, or a combination thereof. In some examples, the UE 115-f may receive multiple PDCCH orders triggering parallel random access procedures based on having transmitted the capability message.

In some examples, one or more network entities 105 may trigger multiple random access procedures for a same CC or different CCs, or both, and at least one CC may be configured with two different TAGs. For example, the UE 115-f may receive signaling (e.g., RRC signaling, system information, dynamic signaling, or the like), indicating a configuration of a first CC (e.g., CC1) associated with one or more TAGS (e.g., TAG1 and TAG2) and a second CC (e.g., CC2) associated with at least a third timing advance group (e.g., associated with TAG1 and TAG3). In some examples, a first random access procedure and a second random access procedure may be associated with CC1.

The UE 115-f may support a threshold number (e.g., four) parallel random access procedures if one or more conditions are satisfied. For example, the UE 115-f may perform an ongoing random access procedure for CC1 triggered by a first PDCCH order associated with a first CORESET pool index value. The UE 115-f may receive a second PDCCH order triggering another random access procedure for a second CC associated with a second CORESET pool index value that is different than the first CORESET pool index value. In such examples, the UE 115-f may support both parallel random access procedures (e.g., as described with reference to FIG. 4). Such techniques may also be performed for different CCs, and the first random access procedure and the second random access procedure may be for different TAGs (e.g., TAG1 and TAG2). Additionally, the UE 115-f may receive another PDCCH order triggering another random access procedure for a CC (e.g., CC2), and a same CORESET pool index as the first PDCCH order. In such examples, the UE 115-f may support the additional random access procedure if the additional CORESET pool index value is not associated with a common TAG between the first CC and the second CC (e.g., the first CC and the second CC are different).

For example, at 705-a, the UE 115-f may receive a first PDCCH order associated with a first random access procedure for CC1. The first PDCCH order may be associated with a first CORESET pool index which is associated with TAG1. At 705-b, the UE 115-f may receive a second PDCCH order associated with a second random access procedure for CC1. The second PDCCH order may be associated with a second CORESET pool index which is associated with TAG 2, and may be different from the first CORESET pool index. In such examples, the UE 115-f may determine that the one or more rules are satisfied if the CORESET pool indices are different, and may support both the first random access procedure and the second random access procedure in parallel (e.g., may transmit a random access preamble at 710-a using a first beam for the first random access procedure and receive a RAR at 715-a, and may transmit a second random access preamble at 710-b for the second random access procedure using a second beam and receive a second RAR at 715-b).

At 705-c, the UE 115-f may receive a third PDCCH order (e.g., prior to completion of the first random access procedure, the second random access procedure, or both). The third PDCCH command may be associated with TAG3, and CC2, but may have a same CORESET pool index as the first PDCCH order received at 705-a. In such examples, the UE 115-e may determine that the one or more conditions are satisfied if the CORESET pool index values of the first PDCCH order and the third PDCCH order are not associated with the common TAGs between the first CC and the second CC. That is, the UE 115-f may not support a third random access procedure if the third PDCCH order were associated with the CORESET pool index that is associated with TAG1 (e.g., a common TAG between the first PDCCH order and the third PDCCH order). However, if the third PDCCH order received at 705-c is associated with TAG3 (e.g., which is different from TAG1), then the UE 115-f may support the first random access procedure and the third random access procedure in parallel (e.g., the UE 115-f may transmit a third random access preamble at 710-c using the second beam, and may receive a third RAR at 715-c).

The UE 115-f may not support multiple random access procedures in parallel if a second PDCCH order associated with a second CC associated with a second CORESET pool index value (e.g., that is the same as the first CORESET pool index value) is associated with a common TAG between the first CC and the second CC. This may be the case because different CCs may be associated with a same TAG (e.g., CC1 may be associated with TAG1 and TAG2, and CC 2 may be associated with TAG2 and TAG3, or CC1 may be associated with TAG 1 and TAG2, and CC2 may be associated with TAG 1 and TAG 2).

The UE 115-f may be able to support up to a threshold number (e.g., four) of parallel random access procedures, if the one or more conditions are satisfied, as described herein. In some examples, the UE 115-f may receive (e.g., from a network entity 105) a PDDCH order that exceeds the threshold (e.g., a fifth PDCCH order), and may refrain from initiating the additional random access procedure in parallel based on the new PDCCH order exceeding the threshold number of parallel random access procedures.

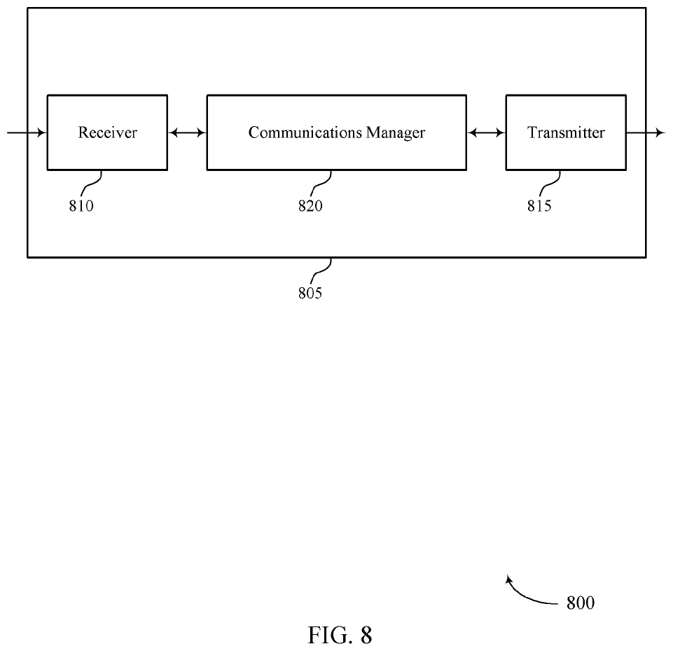

FIG. 8 shows a block diagram 800 of a device 805 that supports performing multiple parallel random access procedures in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to performing multiple parallel random access procedures). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to performing multiple parallel random access procedures). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of performing multiple parallel random access procedures as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communications at a UE in accordance with examples as disclosed herein. For example, the communications manager 820 may be configured as or otherwise support a means for receiving a first control message triggering a first random access procedure. The communications manager 820 may be configured as or otherwise support a means for transmitting a first random access preamble message associated with the first random access procedure based on receiving the first control message. The communications manager 820 may be configured as or otherwise support a means for receiving a second control message triggering a second random access procedure. The communications manager 820 may be configured as or otherwise support a means for transmitting, prior to completion of the first random access procedure and based on one or more conditions being satisfied, a second random access preamble message associated with the second random access procedure based on receiving the second control message.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for random access procedures resulting in more efficient utilization of communication resources, decreased latency, and high reliability communications. For example, the device 805 may support the performance of multiple parallel random access procedures with multiple TRPs or CCs. By supporting multiple parallel random access procedures with the multiple TRPs or CCs, the latency for uplink synchronization may be reduced. In contrast to performing multiple random access procedures individually, supporting multiple random access procedures simultaneously may provide for improved utilization of resources. Additionally, supporting multiple parallel random access procedures may reduce the amount of failed or dropped communications. For example, if a second random access procedure is triggered prior to the completion of a first random access procedure, the device 805 may support the performance of the first and second RACH procedures simultaneously instead of dropping one of the first and second RACH procedures. By reducing the amount of failed or dropped communications, the device 805 may support improved reliability of communications, decreased latency, and improved user experience.

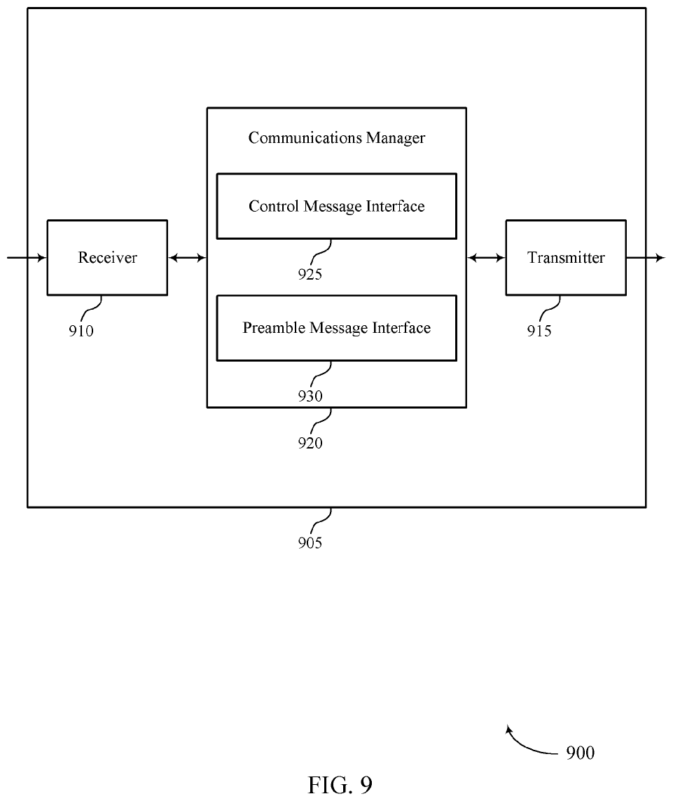

FIG. 9 shows a block diagram 900 of a device 905 that supports performing multiple parallel random access procedures in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to performing multiple parallel random access procedures). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to performing multiple parallel random access procedures). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of performing multiple parallel random access procedures as described herein. For example, the communications manager 920 may include a control message interface 925 a preamble message interface 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The control message interface 925 may be configured as or otherwise support a means for receiving a first control message triggering a first random access procedure. The preamble message interface 930 may be configured as or otherwise support a means for transmitting a first random access preamble message associated with the first random access procedure based on receiving the first control message. The control message interface 925 may be configured as or otherwise support a means for receiving a second control message triggering a second random access procedure. The preamble message interface 930 may be configured as or otherwise support a means for transmitting, prior to completion of the first random access procedure and based on one or more conditions being satisfied, a second random access preamble message associated with the second random access procedure based on receiving the second control message.

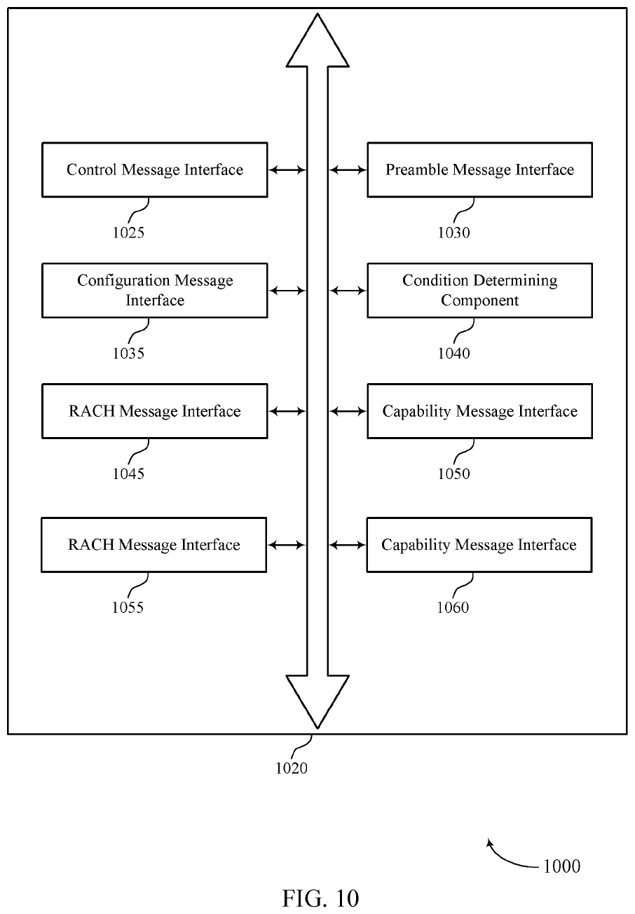

FIG. 10 shows a block diagram 1000 of a communications manager 1020 that supports performing multiple parallel random access procedures in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of performing multiple parallel random access procedures as described herein. For example, the communications manager 1020 may include a control message interface 1025, a preamble message interface 1030, a configuration message interface 1035, a condition determining component 1040, a RA message interface 1045, a RAR message interface 1050, a capability message interface 1055, a RACH message interface 1060, or any combination thereof. Each of these components may communicate, directly or indirectly, with one another (e.g., via one or more buses).

Additionally, or alternatively, the communications manager 1020 may support wireless communications at a UE in accordance with examples as disclosed herein. The control message interface 1025 may be configured as or otherwise support a means for receiving a first control message triggering a first random access procedure. The preamble message interface 1030 may be configured as or otherwise support a means for transmitting a first random access preamble message associated with the first random access procedure based on receiving the first control message. In some examples, the control message interface 1025 may be configured as or otherwise support a means for receiving a second control message triggering a second random access procedure. In some examples, the preamble message interface 1030 may be configured as or otherwise support a means for transmitting, prior to completion of the first random access procedure and based on one or more conditions being satisfied, a second random access preamble message associated with the second random access procedure based on receiving the second control message.

In some examples, the configuration message interface 1035 may be configured as or otherwise support a means for receiving signaling indicating a configuration of a first component carrier associated with a first timing advance group and a second timing advance group, where the first random access procedure and the second random access procedure are associated with the first component carrier. In some examples, the condition determining component 1040 may be configured as or otherwise support a means for determining that the one or more conditions are satisfied based on a first control resource set pool index associated with the first control message being different than a second control resource set pool index associated with the second control message.

In some examples, the configuration message interface 1035 may be configured as or otherwise support a means for receiving signaling indicating a configuration of a first timing advance group associated with a first component carrier, and a second timing advance group associated with a second component carrier, where the first random access procedure is associated with the first component carrier and the second random access procedure is associated with the second component carrier. In some examples, the condition determining component 1040 may be configured as or otherwise support a means for determining that the one or more conditions are satisfied based on a first component carrier being associated with the first timing advance group and the second component carrier being associated with the second timing advance group that is different than the first timing advance group.

In some examples, the configuration message interface 1035 may be configured as or otherwise support a means for receiving signaling indicating a configuration of a first set of component carriers and a second set of component carriers, where each component carrier of the first set of component carriers is associated with one or more timing advance groups of a first set of timing advance groups and each component carrier of the second set of component carriers is associated with one or more timing advance groups of a second set of timing advance groups. In some examples, the condition determining component 1040 may be configured as or otherwise support a means for determining that the one or more conditions are satisfied based on the first random access procedure being triggered for a first component carrier of the first set of component carriers and the second random access procedure being triggered for a first component carrier of the second set of component carriers.

In some examples, the UE supports up to two random access procedures that at least partially overlap in time for the first set of component carriers and up to two random access procedures that at least partially overlap in time for the second set of component carriers based on the one or more conditions being satisfied.

In some examples, the condition determining component 1040 may be configured as or otherwise support a means for determining that the one or more conditions are satisfied based on each random access procedure associated with a respective set of component carriers being associated with different control resource set pool indices.

In some examples, the configuration message interface 1035 may be configured as or otherwise support a means for receiving signaling indicating a configuration of a first component carrier associated with a first timing advance group and a second timing advance group and a second component carrier associated with at least a third timing advance group, and where the first random access procedure and the second random access procedure are associated with the first component carrier. In some examples, the condition determining component 1040 may be configured as or otherwise support a means for determining that the one or more conditions are satisfied based on a first control resource set pool index associated with the first control message being different than a second control resource set pool index associated with the second control message. In some examples, the control message interface 1025 may be configured as or otherwise support a means for receiving a third control message triggering a third random access procedure associated with the second component carrier and the third timing advance group. In some examples, the condition determining component 1040 may be configured as or otherwise support a means for determining that the one or more conditions are satisfied based at least in part on the third timing advance group being different from the first timing advance group and the second timing advance group. In some examples, the preamble message interface 1030 may be configured as or otherwise support a means for transmitting, prior to completion of the first random access procedure based on the one or more conditions being satisfied, a third random access preamble message associated with a third random access procedure based on receiving the third control message.

In some examples, the RA message interface 1045 may be configured as or otherwise support a means for receiving a first random access response message associated with the first random access procedure based on transmitting the first random access preamble message. In some examples, the RAR message interface 1050 may be configured as or otherwise support a means for receiving a second random access response message associated with the second random access procedure based on transmitting the second random access preamble message.

In some examples, the capability message interface 1055 may be configured as or otherwise support a means for transmitting a capability message indicating that the UE is capable of supporting multiple random access procedures that at least partially overlap in time, where receiving the second control message triggering the second random access procedure is based on transmitting the capability message.

In some examples, the capability message includes an indication of a threshold number of random access procedures that at least partially overlap in time that the UE is capable of supporting, an indication of the one or more conditions, or both.

In some examples, the preamble message interface 1030 may be configured as or otherwise support a means for receiving a third control message triggering a third random access procedure prior to completion of the first random access procedure. In some examples, the condition determining component 1040 may be configured as or otherwise support a means for determining that the one or more conditions are not satisfied for the third random access procedure. In some examples, the RACH message interface 1060 may be configured as or otherwise support a means for refraining from initiating the third random access procedure, or initiating the third random access procedure and terminating the first random access procedure, based on the determining.

In some examples, the preamble message interface 1030 may be configured as or otherwise support a means for receiving a third control message triggering a third random access procedure prior to completion of the first random access procedure. In some examples, the condition determining component 1040 may be configured as or otherwise support a means for determining that the third random access procedure exceeds a threshold number of random access procedures that at least partially overlap in time supported by the UE. In some examples, the RACH message interface 1060 may be configured as or otherwise support a means for refraining from initiating the third random access procedure based on the determining.

In some examples, the control message interface 1025 may be configured as or otherwise support a means for receiving the first control message includes receiving the first control message from a first network entity. In some examples, the control message interface 1025 may be configured as or otherwise support a means for receiving the second control message includes receiving the second control message from a second network entity.

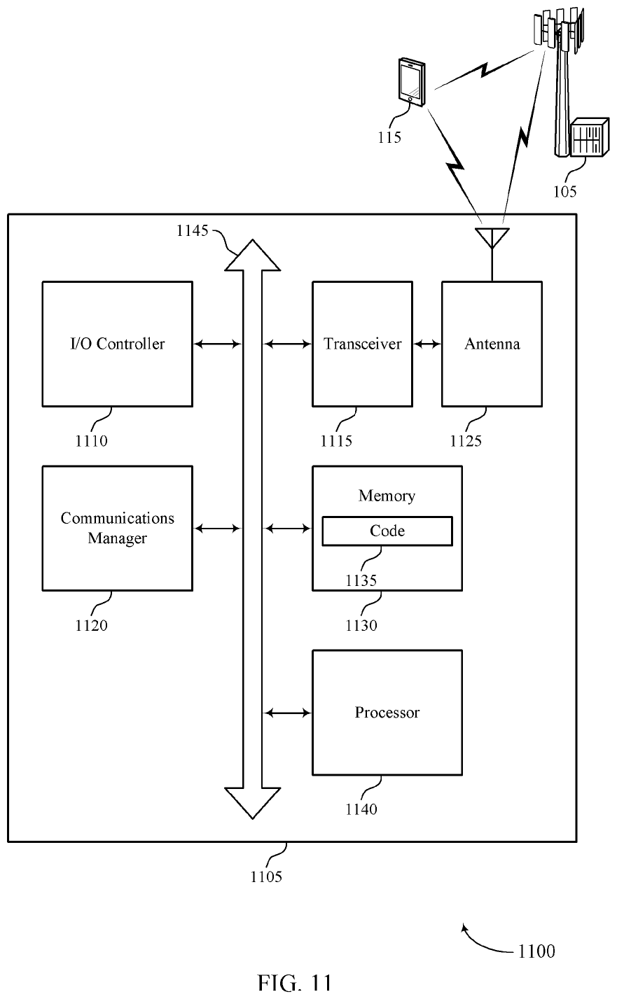

FIG. 11 shows a diagram of a system 1100 including a device 1105 that supports performing multiple parallel random access procedures in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting performing multiple parallel random access procedures). For example, the device 1105 or a component of the device 1105 may include a processor 1140 and memory 1130 coupled with or to the processor 1140, the processor 1140 and memory 1130 configured to perform various functions described herein.

Additionally, or alternatively, the communications manager 1120 may support wireless communications at a UE in accordance with examples as disclosed herein. For example, the communications manager 1120 may be configured as or otherwise support a means for receiving a first control message triggering a first random access procedure. The communications manager 1120 may be configured as or otherwise support a means for transmitting a first random access preamble message associated with the first random access procedure based on receiving the first control message. The communications manager 1120 may be configured as or otherwise support a means for receiving a second control message triggering a second random access procedure. The communications manager 1120 may be configured as or otherwise support a means for transmitting, prior to completion of the first random access procedure and based on one or more conditions being satisfied, a second random access preamble message associated with the second random access procedure based on receiving the second control message.

By including or configuring the communications manager 1120 in accordance with examples as described herein, the device 1105 may support techniques for random access procedures resulting in more efficient utilization of communication resources, reduced latency, improved communication reliability, and improved user experience. For example, the device 805 may support the performance of multiple parallel random access procedures with multiple TRPs or CCs. By supporting multiple parallel random access procedures with the multiple TRPs or CCs, the latency for uplink synchronization may be reduced. In contrast to performing multiple random access procedures individually, supporting multiple random access procedures simultaneously may provide for improved utilization of resources. Additionally, supporting multiple parallel random access procedures may reduce the amount of failed or dropped communications. For example, if a second random access procedure is triggered prior to the completion of a first random access procedure, the device 805 may support the performance of the first and second RACH procedures simultaneously instead of dropping one of the first and second RACH procedures. By reducing the amount of failed or dropped communications, the device 805 may support improved communication reliability and improved user experience.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of performing multiple parallel random access procedures as described herein, or the processor 1140 and the memory 1130 may be otherwise configured to perform or support such operations.

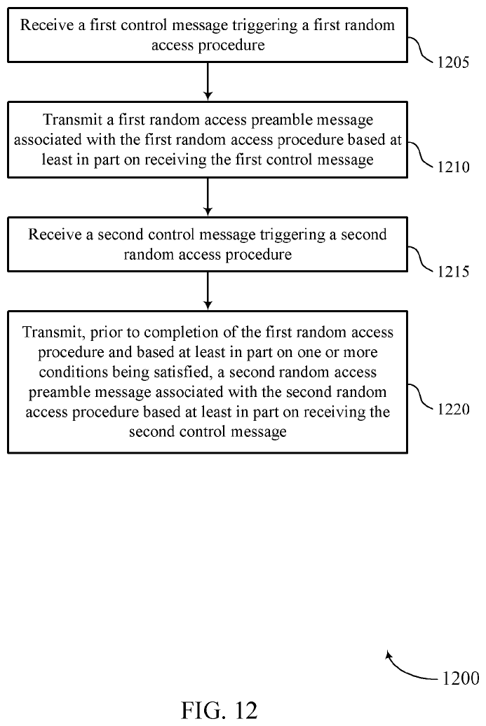

FIG. 12 shows a flowchart illustrating a method 1200 that supports performing multiple parallel random access procedures in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a first control message triggering a first random access procedure. The operations of 1205 may be performed in accordance with examples as disclosed herein. In some examples, aspects of the operations of 1205 may be performed by a control message interface 1025 as described with reference to FIG. 10.

At 1210, the method may include transmitting a first random access preamble message associated with the first random access procedure based on receiving the first control message. The operations of 1210 may be performed in accordance with examples as disclosed herein. In some examples, aspects of the operations of 1210 may be performed by a preamble message interface 1030 as described with reference to FIG. 10.

At 1215, the method may include receiving a second control message triggering a second random access procedure. The operations of 1215 may be performed in accordance with examples as disclosed herein. In some examples, aspects of the operations of 1215 may be performed by a control message interface 1025 as described with reference to FIG. 10.

At 1220, the method may include transmitting, prior to completion of the first random access procedure and based on one or more conditions being satisfied, a second random access preamble message associated with the second random access procedure based on receiving the second control message. The operations of 1220 may be performed in accordance with examples as disclosed herein. In some examples, aspects of the operations of 1220 may be performed by a preamble message interface 1030 as described with reference to FIG. 10.

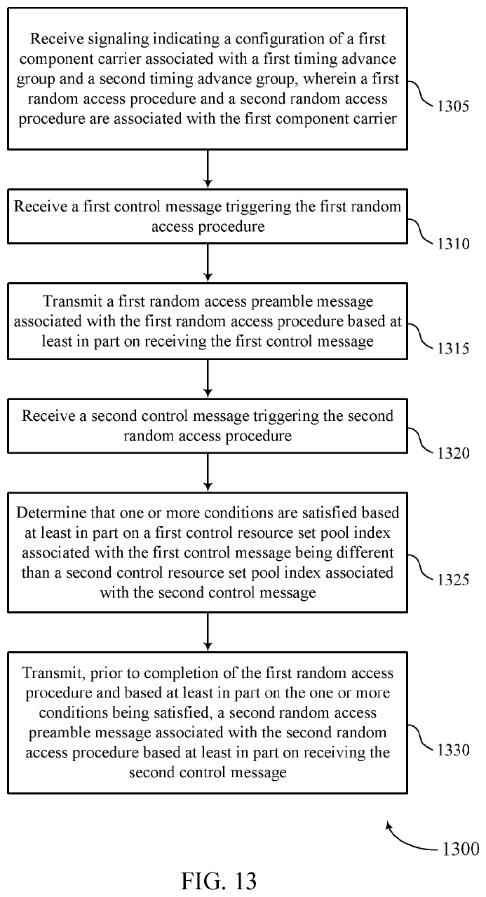

FIG. 13 shows a flowchart illustrating a method 1300 that supports performing multiple parallel random access procedures in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving signaling indicating a configuration of a first component carrier associated with a first timing advance group and a second timing advance group, where the first random access procedure and the second random access procedure are associated with the first component carrier. The operations of 1305 may be performed in accordance with examples as disclosed herein. In some examples, aspects of the operations of 1305 may be performed by a configuration message interface 1035 as described with reference to FIG. 10.

At 1310, the method may include receiving a first control message triggering a first random access procedure. The operations of 1310 may be performed in accordance with examples as disclosed herein. In some examples, aspects of the operations of 1310 may be performed by a control message interface 1025 as described with reference to FIG. 10.

At 1315, the method may include transmitting a first random access preamble message associated with the first random access procedure based on receiving the first control message. The operations of 1315 may be performed in accordance with examples as disclosed herein. In some examples, aspects of the operations of 1315 may be performed by a preamble message interface 1030 as described with reference to FIG. 10.

At 1320, the method may include receiving a second control message triggering a second random access procedure. The operations of 1320 may be performed in accordance with examples as disclosed herein. In some examples, aspects of the operations of 1320 may be performed by a control message interface 1025 as described with reference to FIG. 10.

At 1325, the method may include determining that the one or more conditions are satisfied based on a first control resource set pool index associated with the first control message being different than a second control resource set pool index associated with the second control message. The operations of 1325 may be performed in accordance with examples as disclosed herein. In some examples, aspects of the operations of 1325 may be performed by a condition determining component 1040 as described with reference to FIG. 10.

At 1330, the method may include transmitting, prior to completion of the first random access procedure and based on one or more conditions being satisfied, a second random access preamble message associated with the second random access procedure based on receiving the second control message. The operations of 1330 may be performed in accordance with examples as disclosed herein. In some examples, aspects of the operations of 1330 may be performed by a preamble message interface 1030 as described with reference to FIG. 10.

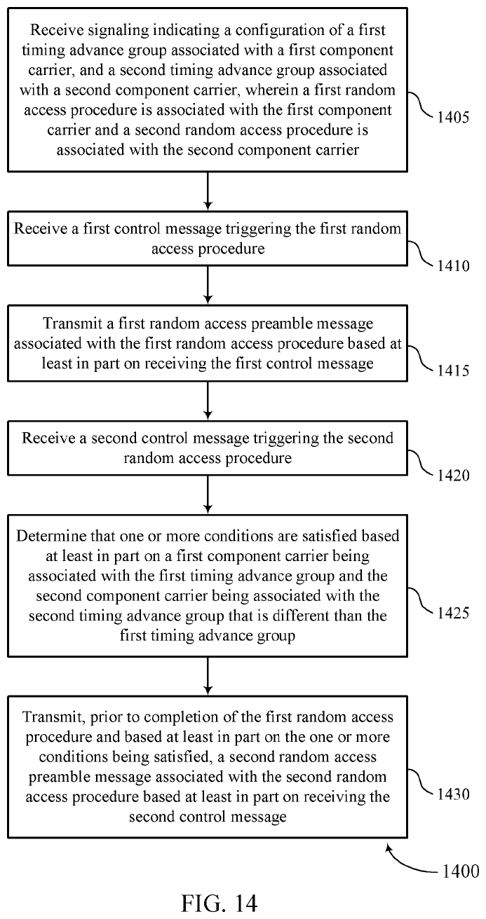

FIG. 14 shows a flowchart illustrating a method 1400 that supports performing multiple parallel random access procedures in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving signaling indicating a configuration of a first timing advance group associated with a first component carrier, and a second timing advance group associated with a second component carrier, where the first random access procedure is associated with the first component carrier and the second random access procedure is associated with the second component carrier. The operations of 1405 may be performed in accordance with examples as disclosed herein. In some examples, aspects of the operations of 1405 may be performed by a configuration message interface 1035 as described with reference to FIG. 10.

At 1410, the method may include receiving a first control message triggering a first random access procedure. The operations of 1410 may be performed in accordance with examples as disclosed herein. In some examples, aspects of the operations of 1410 may be performed by a control message interface 1025 as described with reference to FIG. 10.

At 1415, the method may include transmitting a first random access preamble message associated with the first random access procedure based on receiving the first control message. The operations of 1415 may be performed in accordance with examples as disclosed herein. In some examples, aspects of the operations of 1415 may be performed by a preamble message interface 1030 as described with reference to FIG. 10.

At 1420, the method may include receiving a second control message triggering a second random access procedure. The operations of 1420 may be performed in accordance with examples as disclosed herein. In some examples, aspects of the operations of 1420 may be performed by a control message interface 1025 as described with reference to FIG. 10.

At 1425, the method may include determining that the one or more conditions are satisfied based on a first component carrier being associated with the first timing advance group and the second component carrier being associated with the second timing advance group that is different than the first timing advance group. The operations of 1425 may be performed in accordance with examples as disclosed herein. In some examples, aspects of the operations of 1425 may be performed by a condition determining component 1040 as described with reference to FIG. 10.

At 1430, the method may include transmitting, prior to completion of the first random access procedure and based on one or more conditions being satisfied, a second random access preamble message associated with the second random access procedure based on receiving the second control message. The operations of 1430 may be performed in accordance with examples as disclosed herein. In some examples, aspects of the operations of 1430 may be performed by a preamble message interface 1030 as described with reference to FIG. 10.

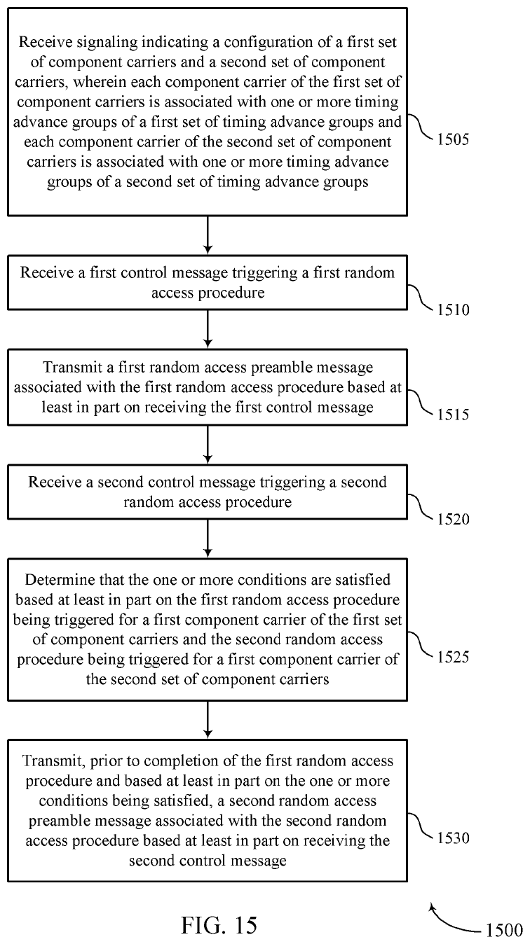

FIG. 15 shows a flowchart illustrating a method 1500 that supports performing multiple parallel random access procedures in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving signaling indicating a configuration of a first set of component carriers and a second set of component carriers, where each component carrier of the first set of component carriers is associated with one or more timing advance groups of a first set of timing advance groups and each component carrier of the second set of component carriers is associated with one or more timing advance groups of a second set of timing advance groups. The operations of 1505 may be performed in accordance with examples as disclosed herein. In some examples, aspects of the operations of 1505 may be performed by a configuration message interface 1035 as described with reference to FIG. 10.

At 1510, the method may include receiving a first control message triggering a first random access procedure. The operations of 1510 may be performed in accordance with examples as disclosed herein. In some examples, aspects of the operations of 1510 may be performed by a control message interface 1025 as described with reference to FIG. 10.

At 1515, the method may include transmitting a first random access preamble message associated with the first random access procedure based on receiving the first control message. The operations of 1515 may be performed in accordance with examples as disclosed herein. In some examples, aspects of the operations of 1515 may be performed by a preamble message interface 1030 as described with reference to FIG. 10.

At 1520, the method may include receiving a second control message triggering a second random access procedure. The operations of 1520 may be performed in accordance with examples as disclosed herein. In some examples, aspects of the operations of 1520 may be performed by a control message interface 1025 as described with reference to FIG. 10.

At 1525, the method may include determining that the one or more conditions are satisfied based on the first random access procedure being triggered for a first component carrier of the first set of component carriers and the second random access procedure being triggered for a first component carrier of the second set of component carriers. The operations of 1525 may be performed in accordance with examples as disclosed herein. In some examples, aspects of the operations of 1525 may be performed by a condition determining component 1040 as described with reference to FIG. 10.

At 1530, the method may include transmitting, prior to completion of the first random access procedure and based on one or more conditions being satisfied, a second random access preamble message associated with the second random access procedure based on receiving the second control message. The operations of 1530 may be performed in accordance with examples as disclosed herein. In some examples, aspects of the operations of 1530 may be performed by a preamble message interface 1030 as described with reference to FIG. 10.

The following provides an overview of aspects of the present disclosure:

Aspect 1: An apparatus for wireless communications at a UE, comprising: a processor; memory coupled with the processor; and instructions stored in the memory and executable by the processor to cause the apparatus to: receive a first control message triggering a first random access procedure; transmit a first random access preamble message associated with the first random access procedure based at least in part on receiving the first control message; receive a second control message triggering a second random access procedure; and transmit, prior to completion of the first random access procedure and based at least in part on one or more conditions being satisfied, a second random access preamble message associated with the second random access procedure based at least in part on receiving the second control message.

Aspect 2: The apparatus of aspect 1, wherein the instructions are further executable by the processor to cause the apparatus to receive signaling indicating a configuration of a first component carrier associated with a first timing advance group and a second timing advance group, wherein the first random access procedure and the second random access procedure are associated with the first component carrier; and determine that the one or more conditions are satisfied based at least in part on a first control resource set pool index associated with the first control message being different than a second control resource set pool index associated with the second control message.

Aspect 3: The apparatus of any of aspects 1 through 2, wherein the instructions are further executable by the processor to cause the apparatus to receive signaling indicating a configuration of a first timing advance group associated with a first component carrier, and a second timing advance group associated with a second component carrier, wherein the first random access procedure is associated with the first component carrier and the second random access procedure is associated with the second component carrier; and determine that the one or more conditions are satisfied based at least in part on a first component carrier being associated with the first timing advance group and the second component carrier being associated with the second timing advance group that is different than the first timing advance group.

Aspect 4: The apparatus of any of aspects 1 through 3, wherein the instructions are further executable by the processor to cause the apparatus to receive signaling indicating a configuration of a first set of component carriers and a second set of component carriers, wherein each component carrier of the first set of component carriers is associated with one or more timing advance groups of a first set of timing advance groups and each component carrier of the second set of component carriers is associated with one or more timing advance groups of a second set of timing advance groups; and determine that the one or more conditions are satisfied based at least in part on the first random access procedure being triggered for a first component carrier of the first set of component carriers and the second random access procedure being triggered for a first component carrier of the second set of component carriers.

Aspect 5: The apparatus of aspect 4, wherein the UE supports up to two random access procedures that at least partially overlap in time for the first set of component carriers and up to two random access procedures that at least partially overlap in time for the second set of component carriers based at least in part on the one or more conditions being satisfied.

Aspect 6: The apparatus of aspect 5, wherein the instructions are further executable by the processor to cause the apparatus to determine that the one or more conditions are satisfied based at least in part on each random access procedure associated with a respective set of component carriers being associated with different control resource set pool indices.

Aspect 7: The apparatus of any of aspects 1 through 6, wherein the instructions are further executable by the processor to cause the apparatus to receive signaling indicating a configuration of a first component carrier associated with a first timing advance group and a second timing advance group and a second component carrier associated with at least a third timing advance group, and wherein the first random access procedure and the second random access procedure are associated with the first component carrier; determine that the one or more conditions are satisfied based at least in part on a first control resource set pool index associated with the first control message being different than a second control resource set pool index associated with the second control message; receive a third control message triggering a third random access procedure associated with the second component carrier and the third timing advance group; determine that the one or more conditions are satisfied based at least in part on the third timing advance group being different from the first timing advance group and the second timing advance group; and transmit, prior to completion of the first random access procedure based at least in part on the one or more conditions being satisfied, a third random access preamble message associated with a third random access procedure based at least in part on receiving the third control message.

Aspect 8: The apparatus of any of aspects 1 through 7, wherein the instructions are further executable by the processor to cause the apparatus to receive a first random access response message associated with the first random access procedure based at least in part on transmitting the first random access preamble message; and receive a second random access response message associated with the second random access procedure based at least in part on transmitting the second random access preamble message.

Aspect 9: The apparatus of any of aspects 1 through 8, wherein the instructions are further executable by the processor to cause the apparatus to transmit a capability message indicating that the UE is capable of supporting multiple random access procedures that at least partially overlap in time, wherein receiving the second control message triggering the second random access procedure is based at least in part on transmitting the capability message.

Aspect 10: The apparatus of aspect 9, wherein the capability message comprises an indication of a threshold number of random access procedures that at least partially overlap in time that the UE is capable of supporting, an indication of the one or more conditions, or both.

Aspect 11: The apparatus of any of aspects 1 through 10, wherein the instructions are further executable by the processor to cause the apparatus to receive a third control message triggering a third random access procedure prior to completion of the first random access procedure; determine that the one or more conditions are not satisfied for the third random access procedure; and refrain from initiating the third random access procedure, or initiating the third random access procedure and terminating the first random access procedure, based at least in part on the determining.

Aspect 12: The apparatus of any of aspects 1 through 11, wherein the instructions are further executable by the processor to cause the apparatus to receive a third control message triggering a third random access procedure prior to completion of the first random access procedure; determine that the third random access procedure exceeds a threshold number of random access procedures that at least partially overlap in time supported by the UE; and refrain from initiating the third random access procedure based at least in part on the determining.

Aspect 13: The apparatus of any of aspects 1 through 12, wherein the instructions are further executable by the processor to cause the apparatus to receive the first control message comprises receiving the first control message from a first network entity; and receive the second control message comprises receiving the second control message from a second network entity.

Aspect 14: A method for wireless communications at a UE, comprising: receiving a first control message triggering a first random access procedure; transmitting a first random access preamble message associated with the first random access procedure based at least in part on receiving the first control message; receiving a second control message triggering a second random access procedure; and transmitting, prior to completion of the first random access procedure and based at least in part on one or more conditions being satisfied, a second random access preamble message associated with the second random access procedure based at least in part on receiving the second control message.

Aspect 15: The method of aspect 14, further comprising: receiving signaling indicating a configuration of a first component carrier associated with a first timing advance group and a second timing advance group, wherein the first random access procedure and the second random access procedure are associated with the first component carrier; and determining that the one or more conditions are satisfied based at least in part on a first control resource set pool index associated with the first control message being different than a second control resource set pool index associated with the second control message.

Aspect 16: The method of any of aspects 14 through 15, further comprising: receiving signaling indicating a configuration of a first timing advance group associated with a first component carrier, and a second timing advance group associated with a second component carrier, wherein the first random access procedure is associated with the first component carrier and the second random access procedure is associated with the second component carrier; and determining that the one or more conditions are satisfied based at least in part on a first component carrier being associated with the first timing advance group and the second component carrier being associated with the second timing advance group that is different than the first timing advance group.

Aspect 17: The method of any of aspects 14 through 16, further comprising: receiving signaling indicating a configuration of a first set of component carriers and a second set of component carriers, wherein each component carrier of the first set of component carriers is associated with one or more timing advance groups of a first set of timing advance groups and each component carrier of the second set of component carriers is associated with one or more timing advance groups of a second set of timing advance groups; and determining that the one or more conditions are satisfied based at least in part on the first random access procedure being triggered for a first component carrier of the first set of component carriers and the second random access procedure being triggered for a first component carrier of the second set of component carriers.

Aspect 18: The method of aspect 17, wherein the UE supports up to two random access procedures that at least partially overlap in time for the first set of component carriers and up to two random access procedures that at least partially overlap in time for the second set of component carriers based at least in part on the one or more conditions being satisfied.

Aspect 19: The method of aspect 18, further comprising: determining that the one or more conditions are satisfied based at least in part on each random access procedure associated with a respective set of component carriers being associated with different control resource set pool indices.

Aspect 20: The method of any of aspects 14 through 19, further comprising: receiving signaling indicating a configuration of a first component carrier associated with a first timing advance group and a second timing advance group and a second component carrier associated with at least a third timing advance group, and wherein the first random access procedure and the second random access procedure are associated with the first component carrier; determining that the one or more conditions are satisfied based at least in part on a first control resource set pool index associated with the first control message being different than a second control resource set pool index associated with the second control message; receiving a third control message triggering a third random access procedure associated with the second component carrier and the third timing advance group; determining that the one or more conditions are satisfied based at least in part on the third timing advance group being different from the first timing advance group and the second timing advance group; and transmitting, prior to completion of the first random access procedure based at least in part on the one or more conditions being satisfied, a third random access preamble message associated with a third random access procedure based at least in part on receiving the third control message.

Aspect 21: The method of any of aspects 14 through 20, further comprising: receiving a first random access response message associated with the first random access procedure based at least in part on transmitting the first random access preamble message; and receiving a second random access response message associated with the second random access procedure based at least in part on transmitting the second random access preamble message.

Aspect 22: The method of any of aspects 14 through 21, further comprising: transmitting a capability message indicating that the UE is capable of supporting multiple random access procedures that at least partially overlap in time, wherein receiving the second control message triggering the second random access procedure is based at least in part on transmitting the capability message.

Aspect 23: The method of aspect 22, wherein the capability message comprises an indication of a threshold number of random access procedures that at least partially overlap in time that the UE is capable of supporting, an indication of the one or more conditions, or both.

Aspect 24: The method of any of aspects 14 through 23, further comprising: receiving a third control message triggering a third random access procedure prior to completion of the first random access procedure; determining that the one or more conditions are not satisfied for the third random access procedure; and refraining from initiating the third random access procedure, or initiating the third random access procedure and terminating the first random access procedure, based at least in part on the determining.

Aspect 25: The method of any of aspects 14 through 24, further comprising: receiving a third control message triggering a third random access procedure prior to completion of the first random access procedure; determining that the third random access procedure exceeds a threshold number of random access procedures that at least partially overlap in time supported by the UE; and refraining from initiating the third random access procedure based at least in part on the determining.

Aspect 26: The method of any of aspects 14 through 25, further comprising: receiving the first control message comprises receiving the first control message from a first network entity; and receiving the second control message comprises receiving the second control message from a second network entity.

Aspect 27: An apparatus comprising a processor; memory coupled with the processor; and instructions stored in the memory and executable by the processor to cause the apparatus to perform a method of any of aspects 1 through 13.

Aspect 28: An apparatus comprising at least one means for performing a method of any of aspects 1 through 13.

Aspect 29: A non-transitory computer-readable medium storing code the code comprising instructions executable by a processor to perform a method of any of aspects 1 through 13.

Aspect 30: An apparatus for wireless communications at a UE, comprising a processor; memory coupled with the processor; and instructions stored in the memory and executable by the processor to cause the apparatus to perform a method of any of aspects 14 through 26.

Aspect 31: An apparatus for wireless communications at a UE, comprising at least one means for performing a method of any of aspects 14 through 26.

Aspect 32: A non-transitory computer-readable medium storing code for wireless communications at a UE, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a first control message triggering a first random access procedure;
transmit a first random access preamble message associated with the first random access procedure based at least in part on receiving the first control message;
receive a second control message triggering a second random access procedure; and
transmit, prior to completion of the first random access procedure and based at least in part on one or more conditions being satisfied, a second random access preamble message associated with the second random access procedure based at least in part on receiving the second control message.

2. The apparatus of claim 1, wherein the instructions are further executable by the processor to cause the apparatus to:
receive signaling indicating a configuration of a first component carrier associated with a first timing advance group and a second timing advance group, wherein the first random access procedure and the second random access procedure are associated with the first component carrier; and
determine that the one or more conditions are satisfied based at least in part on a first control resource set pool index associated with the first control message being different than a second control resource set pool index associated with the second control message.

3. The apparatus of claim 1, wherein the instructions are further executable by the processor to cause the apparatus to:
receive signaling indicating a configuration of a first timing advance group associated with a first component carrier, and a second timing advance group associated with a second component carrier, wherein the first random access procedure is associated with the first component carrier and the second random access procedure is associated with the second component carrier; and
determine that the one or more conditions are satisfied based at least in part on a first component carrier being associated with the first timing advance group and the second component carrier being associated with the second timing advance group that is different than the first timing advance group.

4. The apparatus of claim 1, wherein the instructions are further executable by the processor to cause the apparatus to:
receive signaling indicating a configuration of a first set of component carriers and a second set of component carriers, wherein each component carrier of the first set of component carriers is associated with one or more timing advance groups of a first set of timing advance groups and each component carrier of the second set of component carriers is associated with one or more timing advance groups of a second set of timing advance groups; and
determine that the one or more conditions are satisfied based at least in part on the first random access procedure being triggered for a first component carrier of the first set of component carriers and the second random access procedure being triggered for a first component carrier of the second set of component carriers.

5. The apparatus of claim 4, wherein the UE supports up to two random access procedures that at least partially overlap in time for the first set of component carriers and up to two random access procedures that at least partially overlap in time for the second set of component carriers based at least in part on the one or more conditions being satisfied.

6. The apparatus of claim 5, wherein the instructions are further executable by the processor to cause the apparatus to:
determine that the one or more conditions are satisfied based at least in part on each random access procedure associated with a respective set of component carriers being associated with different control resource set pool indices.

7. The apparatus of claim 1, wherein the instructions are further executable by the processor to cause the apparatus to:
receive signaling indicating a configuration of a first component carrier associated with a first timing advance group and a second timing advance group and a second component carrier associated with at least a third timing advance group, and wherein the first random access procedure and the second random access procedure are associated with the first component carrier;
determine that the one or more conditions are satisfied based at least in part on a first control resource set pool index associated with the first control message being different than a second control resource set pool index associated with the second control message;
receive a third control message triggering a third random access procedure associated with the second component carrier and the third timing advance group;
determine that the one or more conditions are satisfied based at least in part on the third timing advance group being different from the first timing advance group and the second timing advance group; and
transmit, prior to completion of the first random access procedure based at least in part on the one or more conditions being satisfied, a third random access preamble message associated with a third random access procedure based at least in part on receiving the third control message.

8. The apparatus of claim 1, wherein the instructions are further executable by the processor to cause the apparatus to:
receive a first random access response message associated with the first random access procedure based at least in part on transmitting the first random access preamble message; and
receive a second random access response message associated with the second random access procedure based at least in part on transmitting the second random access preamble message.

9. The apparatus of claim 1, wherein the instructions are further executable by the processor to cause the apparatus to:
transmit a capability message indicating that the UE is capable of supporting multiple random access procedures that at least partially overlap in time, wherein receiving the second control message triggering the second random access procedure is based at least in part on transmitting the capability message.

10. The apparatus of claim 9, wherein the capability message comprises an indication of a threshold number of random access procedures that at least partially overlap in time that the UE is capable of supporting, an indication of the one or more conditions, or both.

11. The apparatus of claim 1, wherein the instructions are further executable by the processor to cause the apparatus to:
receive a third control message triggering a third random access procedure prior to completion of the first random access procedure;
determine that the one or more conditions are not satisfied for the third random access procedure; and
refrain from initiating the third random access procedure, or initiating the third random access procedure and terminating the first random access procedure, based at least in part on the determining.

12. The apparatus of claim 1, wherein the instructions are further executable by the processor to cause the apparatus to:
receive a third control message triggering a third random access procedure prior to completion of the first random access procedure;
determine that the third random access procedure exceeds a threshold number of random access procedures that at least partially overlap in time supported by the UE; and
refrain from initiating the third random access procedure based at least in part on the determining.

13. The apparatus of claim 1, wherein the instructions are further executable by the processor to cause the apparatus to:
receive the first control message comprises receiving the first control message from a first network entity; and
receive the second control message comprises receiving the second control message from a second network entity.

14. A method for wireless communications at a user equipment (UE), comprising:
receiving a first control message triggering a first random access procedure;
transmitting a first random access preamble message associated with the first random access procedure based at least in part on receiving the first control message;
receiving a second control message triggering a second random access procedure; and
transmitting, prior to completion of the first random access procedure and based at least in part on one or more conditions being satisfied, a second random access preamble message associated with the second random access procedure based at least in part on receiving the second control message.

15. The method of claim 14, further comprising:
receiving signaling indicating a configuration of a first component carrier associated with a first timing advance group and a second timing advance group, wherein the first random access procedure and the second random access procedure are associated with the first component carrier; and
determining that the one or more conditions are satisfied based at least in part on a first control resource set pool index associated with the first control message being different than a second control resource set pool index associated with the second control message.

16. The method of claim 14, further comprising:
receiving signaling indicating a configuration of a first timing advance group associated with a first component carrier, and a second timing advance group associated with a second component carrier, wherein the first random access procedure is associated with the first component carrier and the second random access procedure is associated with the second component carrier; and
determining that the one or more conditions are satisfied based at least in part on a first component carrier being associated with the first timing advance group and the second component carrier being associated with the second timing advance group that is different than the first timing advance group.

17. The method of claim 14, further comprising:
receiving signaling indicating a configuration of a first set of component carriers and a second set of component carriers, wherein each component carrier of the first set of component carriers is associated with one or more timing advance groups of a first set of timing advance groups and each component carrier of the second set of component carriers is associated with one or more timing advance groups of a second set of timing advance groups; and
determining that the one or more conditions are satisfied based at least in part on the first random access procedure being triggered for a first component carrier of the first set of component carriers and the second random access procedure being triggered for a first component carrier of the second set of component carriers.

18. The method of claim 17, wherein the UE supports up to two random access procedures that at least partially overlap in time for the first set of component carriers and up to two random access procedures that at least partially overlap in time for the second set of component carriers based at least in part on the one or more conditions being satisfied.

19. The method of claim 18, further comprising:
determining that the one or more conditions are satisfied based at least in part on each random access procedure associated with a respective set of component carriers being associated with different control resource set pool indices.

20. The method of claim 14, further comprising:
receiving signaling indicating a configuration of a first component carrier associated with a first timing advance group and a second timing advance group and a second component carrier associated with at least a third timing advance group, and wherein the first random access procedure and the second random access procedure are associated with the first component carrier;
determining that the one or more conditions are satisfied based at least in part on a first control resource set pool index associated with the first control message being different than a second control resource set pool index associated with the second control message;
receiving a third control message triggering a third random access procedure associated with the second component carrier and the third timing advance group;
determining that the one or more conditions are satisfied based at least in part on the third timing advance group being different from the first timing advance group and the second timing advance group; and
transmitting, prior to completion of the first random access procedure based at least in part on the one or more conditions being satisfied, a third random access preamble message associated with a third random access procedure based at least in part on receiving the third control message.

21. The method of claim 14, further comprising:
receiving a first random access response message associated with the first random access procedure based at least in part on transmitting the first random access preamble message; and
receiving a second random access response message associated with the second random access procedure based at least in part on transmitting the second random access preamble message.

22. The method of claim 14, further comprising:
transmitting a capability message indicating that the UE is capable of supporting multiple random access procedures that at least partially overlap in time, wherein receiving the second control message triggering the second random access procedure is based at least in part on transmitting the capability message.

23. The method of claim 22, wherein the capability message comprises an indication of a threshold number of random access procedures that at least partially overlap in time that the UE is capable of supporting, an indication of the one or more conditions, or both.

24. The method of claim 14, further comprising:
receiving a third control message triggering a third random access procedure prior to completion of the first random access procedure;
determining that the one or more conditions are not satisfied for the third random access procedure; and
refraining from initiating the third random access procedure, or initiating the third random access procedure and terminating the first random access procedure, based at least in part on the determining.

25. The method of claim 14, further comprising:
receiving a third control message triggering a third random access procedure prior to completion of the first random access procedure;
determining that the third random access procedure exceeds a threshold number of random access procedures that at least partially overlap in time supported by the UE; and
refraining from initiating the third random access procedure based at least in part on the determining.

26. The method of claim 14, further comprising:
receiving the first control message comprises receiving the first control message from a first network entity; and
receiving the second control message comprises receiving the second control message from a second network entity.

27. A non-transitory computer-readable medium storing code for wireless communications at a user equipment (UE), the code comprising instructions executable by a processor to:
receive a first control message triggering a first random access procedure;
transmit a first random access preamble message associated with the first random access procedure based at least in part on receiving the first control message;
receive a second control message triggering a second random access procedure; and
transmit, prior to completion of the first random access procedure and based at least in part on one or more conditions being satisfied, a second random access preamble message associated with the second random access procedure based at least in part on receiving the second control message.

28. The non-transitory computer-readable medium of claim 27, wherein the instructions are further executable by the processor to:
receive signaling indicating a configuration of a first component carrier associated with a first timing advance group and a second timing advance group, wherein the first random access procedure and the second random access procedure are associated with the first component carrier; and
determine that the one or more conditions are satisfied based at least in part on a first control resource set pool index associated with the first control message being different than a second control resource set pool index associated with the second control message.

29. The non-transitory computer-readable medium of claim 27, wherein the instructions are further executable by the processor to:
receive signaling indicating a configuration of a first timing advance group associated with a first component carrier, and a second timing advance group associated with a second component carrier, wherein the first random access procedure is associated with the first component carrier and the second random access procedure is associated with the second component carrier; and
determine that the one or more conditions are satisfied based at least in part on a first component carrier being associated with the first timing advance group and the second component carrier being associated with the second timing advance group that is different than the first timing advance group.

30. An apparatus for wireless communications at a user equipment (UE), comprising:
means for receiving a first control message triggering a first random access procedure;
means for transmitting a first random access preamble message associated with the first random access procedure based at least in part on receiving the first control message;
means for receiving a second control message triggering a second random access procedure; and
means for transmitting, prior to completion of the first random access procedure and based at least in part on one or more conditions being satisfied, a second random access preamble message associated with the second random access procedure based at least in part on receiving the second control message.
